(19) United States
(12) Patent Application Publication
(10) Pub. No.: US 2026/0291931 A1
(43) Pub. Date: Sep. 24, 2026

(54) SYSTEM

(71) Applicant: SoftBank Group Corp., Tokyo (JP)

(72) Inventor: Yohei SUMIYOSHI, Tokyo (JP)

(73) Assignee: SoftBank Group Corp., Tokyo (JP)

(21) Appl. No.: 19/568,863

(22) Filed: Mar. 17, 2026

(30) Foreign Application Priority Data
Mar. 19, 2025 (JP) 2025-045256

(51) Int. Cl. H04L 9/40; H04L 41/16

(52) U.S. Cl. CPC H04L 63/0823; H04L 41/16

(57) ABSTRACT

A system includes a processor that is configured to monitor a validity period of a digital certificate and generate, by using a generative AI model, a prompt for instructing acquisition of a new certificate when the validity period is approaching expiration, set an acquired digital certificate in an information processing apparatus and generate, by using the generative AI model, a prompt for instructing execution of procedures necessary to complete an electronic transaction, and analyze an emotional state of a user and generate, by using the generative AI model, a prompt for instructing adjustment of timing and content of a notification based on the emotional state.

### CROSS-REFERENCE TO RELATED APPLICATION

This application is based on and claims priority under 35 USC 119 from Japanese Patent Application No. 2025-045256 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for managing digital certificates and related electronic transactions require system administrators or users to manually monitor certificate validity periods, initiate acquisition of new certificates, and perform procedures necessary to complete electronic transactions. When such operations are performed manually or by simple rule-based automation without intelligent support, there is a risk that expiration of a digital certificate may be overlooked, leading to suspension of information services, interruption of secure communication, or failure of electronic transactions. Furthermore, existing notification mechanisms typically use fixed timing and fixed content that do not take a user's emotional state into account. As a result, notifications may be delivered at inappropriate times or in inappropriate forms, causing user stress, reduced responsiveness, or delayed action, and thereby increasing the risk of service downtime or transaction failure. Additionally, current systems generally do not optimize notification priority based on a user's emotional state, so important alerts may not be sufficiently emphasized when a user is under stress or when a particular context requires higher urgency. Accordingly, there is a need for a system that uses a generative AI model to generate prompts that instruct automated certificate management and transaction-related procedures, while at the same time analyzing a user's emotional state in order to adapt notification timing, content, and priority, thereby reducing the risk of certificate-related service interruptions and improving the effectiveness of user notifications.

### SUMMARY

In order to solve the above problems, the present invention provides a system comprising a processor, wherein the processor is configured to monitor a validity period of a digital certificate and generate, by using a generative AI model, a prompt for instructing acquisition of a new certificate when the validity period is approaching expiration. The processor is further configured to set an acquired digital certificate in an information processing apparatus and to generate, by using the generative AI model, a prompt for instructing execution of procedures necessary to complete an electronic transaction, so that processes associated with certificate renewal and electronic transaction completion can be carried out in an automated and consistent manner. In addition, the processor is configured to analyze an emotional state of a user and to generate, by using the generative AI model, a prompt for instructing adjustment of timing and content of a notification based on the emotional state, thereby enabling adaptive communication that matches the user's psychological condition. In one aspect, the processor is configured to generate, by using the generative AI model, a prompt for instructing execution of a notification to prevent suspension of an information service due to expiration of the digital certificate, thereby ensuring that alerts related to certificate expiration are provided before service downtime occurs. In another aspect, the processor is configured to generate, by using the generative AI model, a prompt for instructing optimization of a priority of the notification based on the emotional state of the user, so that critical notifications are emphasized or escalated when necessary, thereby improving the likelihood that the user will respond in a timely and appropriate manner.

The term “system” refers to an aggregation of hardware and software components, including at least one processor and associated memory, configured to execute instructions and perform the processing described in the claims as an integrated whole.

The term “processor” refers to a hardware logic element, such as a central processing unit (CPU), microprocessor, microcontroller, digital signal processor, or other programmable circuitry, capable of executing instructions stored in a memory to perform arithmetic, logical, control, and input/output operations.

The term “digital certificate” refers to an electronic credential, typically compliant with a public key infrastructure standard such as X.509, that binds an entity's identity information to a public key and that includes a validity period defined by a start date and an expiration date.

The term “validity period” refers to a time interval during which a digital certificate is designated as valid by an issuing authority, the interval being defined by an issuance time and an expiration time embedded in the digital certificate.

The term “information processing apparatus” refers to any device or system, including a server, client computer, virtual machine, network appliance, or embedded device, that is capable of executing programs, processing data, and using a digital certificate to perform secure communication or electronic transactions.

The term “generative AI model” refers to a machine learning model, such as a large language model or another generative neural network, that is trained to output text or other content in response to input data, and that is used to generate prompts in natural language or structured form according to the processing described in the claims.

The term “prompt” refers to a text, token sequence, or structured instruction generated by the generative AI model that is used to instruct another system, module, or process to perform one or more operations, including acquisition of a certificate, execution of transaction procedures, or control of notification behavior.

The term “electronic transaction” refers to an exchange of data, payment, or other electronic messages between two or more parties via a communication network, the exchange being performed at least in part by the information processing apparatus and typically requiring use of a digital certificate for authentication, encryption, or integrity protection.

The term “emotional state” refers to a psychological condition or affective state of a user, such as stress, anxiety, calmness, urgency, or satisfaction, which is inferred or estimated based on one or more inputs including user behavior, interaction patterns, biometric data, or explicit feedback.

The term “notification” refers to a message, alert, or indication, delivered to a user via a user interface, email, messaging service, dashboard, or other communication channel, that provides information regarding certificate status, transaction progress, system events, or required user actions.

The term “timing of a notification” refers to one or more temporal parameters defining when a notification is generated or delivered to the user, including an absolute time, a time relative to an event such as certificate expiration, or a schedule adjusted based on the user's emotional state.

The term “content of a notification” refers to the information included in a notification, such as text, symbols, layout, level of detail, tone, and recommended actions, which can be adapted according to the user's emotional state or system context.

The term “priority of a notification” refers to a relative importance level or urgency level assigned to a notification, which can influence ordering, visual emphasis, escalation behavior, delivery channel selection, or repetition frequency of the notification.

The term “information service” refers to a service provided through a communication network that delivers data, applications, or functionalities to users or other systems, including web services, APIs, online applications, and transaction platforms, which may rely on digital certificates for secure operation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

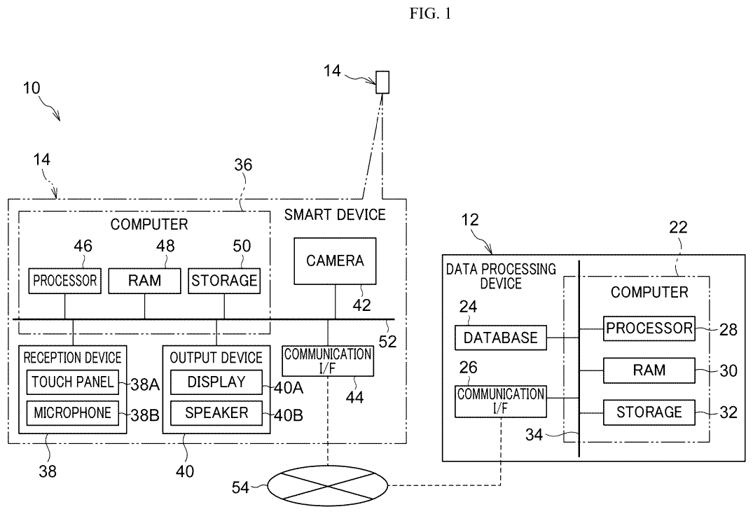

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

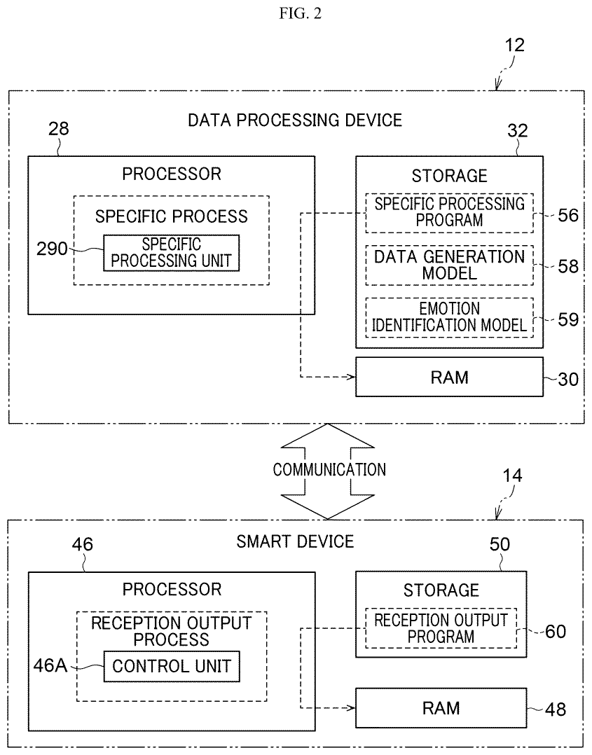

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional mechanisms for managing digital certificates on networked information processing resources generally rely on fixed-purpose scripts, manually maintained configuration files, and human operators to design, deploy, and maintain automation workflows. In such mechanisms, a processor typically performs certificate expiration checks, interacts with certificate issuing services, and updates communication control configurations according to static procedures that must be crafted and adapted by experts. As a result, the underlying computer technology suffers from several technical limitations.

First, existing systems lack a flexible, machine-assisted way to generate or adapt the concrete control logic that performs certificate monitoring, acquisition, installation, and associated electronic transactions. When network topologies, service interfaces, or security policies change, administrators must manually rewrite scripts and configuration files. This manual adaptation introduces latency and error, increases the likelihood of misconfigured certificate paths, incorrect name resolution entries, and inconsistent scheduling settings, and leads to failures in automated renewal pipelines. These failures can directly cause termination of secure communication sessions and suspension of information providing services. Second, conventional systems do not integrate a generative artificial intelligence model as a programmable subsystem that can dynamically synthesize prompt sentences describing executable processing procedures, configuration information, and program code in response to the current state of digital certificates and infrastructure. Without such an integration, the processor cannot offload the generation of complex orchestration logic to a machine-learned model that internalizes a broad range of protocol patterns, configuration idioms, and error-handling strategies. This prevents the computing system from achieving higher robustness and adaptability at the software control layer.

Third, existing designs typically treat notifications to administrators and users as static messages triggered by simple threshold conditions. They do not consider the emotional state of the user as a computer-consumable parameter to control when and how notifications are issued. This leads to suboptimal notification timing, priority, and content, which can either overwhelm operators with low-value alerts or delay critical interventions when automated renewal fails. From a computer-technical perspective, the notification subsystem remains a coarse-grained, low-level control path that is not well integrated with higher-level context derived from user state.

Fourth, conventional certificate automation tools are usually bound to a specific software stack, a particular certificate issuing protocol implementation, or a single payment interface. When a new certificate issuing communication protocol, payment interface, or resource allocation mechanism is introduced, the processor must be reprogrammed directly at the source code level. There is no standardized mechanism for generating, from higher-level descriptions, the concrete program code and configuration updates required to safely perform domain validation, electronic transactions, certificate deployment, and verification across heterogeneous computing environments.

Therefore, there is a need for an improved computer-implemented system in which a processor cooperates with a generative artificial intelligence model by exchanging structured prompt sentences. Such a system should automatically derive, update, and deploy the executable procedures, configuration information, and program code necessary for end-to-end certificate lifecycle management, including monitoring, certificate issuing interactions, payment processing, storage and configuration of obtained certificates, verification and reload of communication control components, and adaptive notification control based on user emotional state. By embedding the generative artificial intelligence model into the control path as a tool for synthesizing machine-executable logic, the underlying computer technology can be improved in terms of reliability, scalability, and maintainability of certificate management operations, and can better prevent service interruption due to certificate expiration.

The specific processing by the specific processing unit 290 of the data processing device 12 in Example 1 is realized by the following means.

The present invention provides a server comprising a processor configured to acquire validity period information of a digital certificate from an information processing resource, to determine, based on date-time information, whether a remaining validity period of the digital certificate is within a predetermined period, and to invoke a generative artificial intelligence model to generate prompt sentences that specify processing procedures, configuration information, and program code for automatically executing, in response to a determination that the remaining validity period is within the predetermined period, a request to a certificate issuing service using a certificate issuing communication protocol, electronic transaction processing related to acquisition of a new digital certificate, processing of authentication information and automatic generation or updating of resource allocation information or name resolution information used for responding to the authentication information, storage of an obtained digital certificate and secret information in a storage resource, updating, verification, and restart or reload of configuration information of a communication control information processing apparatus, execution of notification operations based on a validity period or a renewal result of the digital certificate, deployment and periodic scheduling of an automatic renewal process on the information processing resource, and analysis of information representing an emotional state of a user together with adaptive control of notification timing and notification content according to an evaluation index of the emotional state. This enables the server to improve computer-implemented certificate lifecycle management by automatically synthesizing and deploying executable control logic and configuration updates through interaction with the generative artificial intelligence model, thereby enhancing robustness and adaptability of secure communication services, reducing manual intervention and configuration errors, and dynamically optimizing notification behavior in accordance with user state.

The term “system” refers to an arrangement of one or more information processing resources including at least one processor and associated memory, storage, and communication interfaces that cooperate to perform the claimed functions.

The term “processor” refers to one or more hardware processing units, such as a central processing unit or a processing core, capable of executing instructions to perform arithmetic, logical, control, and input/output operations.

The term “information processing resource” refers to a hardware and software platform, including computing equipment, operating systems, and application programs, on which digital data is stored, processed, and communicated.

The term “digital certificate” refers to electronic authentication data that binds an identity to a cryptographic public key and includes validity period information and issuer information for use in secure communication.

The term “validity period information” refers to data indicating one or more dates or times, such as a start date and an expiration date, during which a digital certificate is considered valid for use.

The term “remaining validity period” refers to a duration computed from a current date-time to an expiration date of a digital certificate.

The term “predetermined period” refers to a threshold duration, defined in advance, used to determine whether a remaining validity period of a digital certificate is considered close to expiration.

The term “date-time information” refers to data representing absolute or relative points in time, including at least a current time and an expiration time, usable for temporal comparison and calculation.

The term “generative artificial intelligence model” refers to a machine-learned computational model configured to generate sequences of tokens, text, or program code in response to input data, using parameters trained on example data.

The term “prompt sentence” refers to an input sequence of tokens or text provided to a generative artificial intelligence model to condition or control generation of output text, program code, configuration information, or processing procedures.

The term “certificate issuing service” refers to a network-accessible service operated by a certificate authority or similar entity that receives certificate requests, performs validation, and issues digital certificates.

The term “certificate issuing communication protocol” refers to a standardized or predefined communication procedure by which a client and a certificate issuing service exchange messages for requesting, validating, and issuing digital certificates.

The term “authentication information” refers to data provided by a certificate issuing service to prove or verify control over a resource, including challenge tokens, validation records, or similar data.

The term “resource allocation information” refers to configuration data specifying how computing or communication resources, such as files, directories, or service endpoints, are assigned or arranged to satisfy an authentication or communication requirement.

The term “name resolution information” refers to data used to map a symbolic identifier, such as a domain name, to one or more network addresses or records for use in communication or validation procedures.

The term “processing procedures” refers to ordered steps, operations, or control flows that, when executed by a processor, perform a defined data processing or control task.

The term “configuration information” refers to data or settings that determine operational behavior of software components or hardware components, including paths, parameters, and options controlling secure communication or certificate use.

The term “program code” refers to instructions written in a programming language or script language that can be interpreted or executed by a processor to perform one or more processing procedures.

The term “electronic transaction” refers to a sequence of operations executed over a communication network to complete a commercial or contractual process, including payment processing and confirmation exchanges.

The term “settlement processing” refers to electronic payment operations performed through a payment service, including authorization, capture, and confirmation of charges.

The term “connection interface for a settlement service” refers to an application programming interface, communication endpoint, or protocol interface that enables a computing system to send and receive payment-related messages to and from a payment service.

The term “storage resource” refers to hardware and software components, such as memory devices and file systems, used to store and retrieve digital data in a persistent or semi-persistent manner.

The term “secret information” refers to data that must be protected from unauthorized access, including private keys, authentication credentials, and confidential configuration values.

The term “communication control information processing apparatus” refers to an information processing component, including hardware and software, that manages or terminates communication sessions, such as a network server or a communication gateway.

The term “verification of configuration information” refers to a process of checking configuration information for syntactic correctness, semantic consistency, or conformity with predefined rules, before or after deployment.

The term “restart or reload of configuration information” refers to operations that cause a software component or service to reinitialize or re-read configuration information so that updated settings take effect.

The term “notification operation” refers to processing that generates and transmits messages or alerts to one or more destinations using one or more communication media.

The term “destination information” refers to data that specifies recipients or endpoints of a notification, such as identifiers for accounts, addresses, or devices.

The term “notification media” refers to communication channels or mechanisms through which notifications are delivered, including electronic mail, messaging services, or dashboard interfaces.

The term “automatic renewal process” refers to a sequence of computer-executed operations that continuously and periodically monitor, request, obtain, install, and verify digital certificates without requiring manual intervention for each renewal cycle.

The term “periodic execution control mechanism” refers to a scheduling facility, such as a task scheduler or timer subsystem, that automatically initiates execution of registered processes at defined intervals or times.

The term “deployment” refers to operations for placing program code or processing procedures into an execution environment and configuring the environment so that the code or procedures can be executed by a processor.

The term “user” refers to a human operator or entity that interacts with the system, including providing prompt sentences, reviewing generated outputs, and receiving notifications.

The term “information representing an emotional state of a user” refers to data that indicates or can be used to infer a psychological or affective condition of the user, derived from explicit input, behavioral logs, or other measurable signals.

The term “evaluation index of the emotional state” refers to one or more computed values or scores derived from information representing the emotional state of the user, used as parameters for control of system behavior.

The term “notification timing” refers to one or more points in time, or a schedule, at which a notification operation is initiated.

The term “notification content” refers to the textual, visual, or structured data payload included in a notification message, including explanation of events, status, or recommended actions.

The term “notification priority” refers to a relative importance level assigned to a notification, used to influence ordering, emphasis, or delivery guarantees.

The term “notification frequency” refers to a rate or count that indicates how often notifications of a particular type are generated or sent within a given time period.

The term “notification text” refers to the text portion of a notification message that is displayed or presented to a recipient.

The term “notification control logic” refers to rules, conditions, and decision procedures used by a processor to determine whether, when, and how to generate and transmit notifications.

The term “monitoring” refers to continuous or periodic observation and evaluation of data related to digital certificates, system status, or processes to detect conditions requiring action. The term “obtaining” refers to actions for requesting, receiving, and storing digital certificates or related data from external or internal sources.

The term “setting” refers to operations for associating obtained digital certificates and related data with communication services or software components so that the certificates are used in secure communications.

The term “renewal result” refers to information indicating success, failure, or status of an attempt to renew a digital certificate, including details of errors or confirmations.

The term “information providing processing” refers to operations in which an information processing resource transmits content, data, or services to external entities over a network. The term “countermeasure procedures” refers to defined sequences of actions that are executed by a processor to avoid, mitigate, or recover from an undesired condition, such as service suspension due to certificate expiration.

The term “setting methods for automatically executing the countermeasure procedures” refers to operations and configurations by which countermeasure procedures are registered, scheduled, or enabled for automatic execution by a computing system.

The term “execution result of the countermeasure procedures” refers to data indicating the outcome of executing countermeasure procedures, including success, failure, or partial completion, and associated diagnostic information.

In one embodiment, a server manages digital certificates for communication services by using a generative AI model to synthesize executable processing procedures, configuration information, and program code. The server is implemented on a computing platform such as a rack-mounted or virtualized x86-compatible machine running a multitasking operating system, for example a Linux-based operating system. The server includes at least one processor, a main memory, persistent storage such as a magnetic disk or solid-state drive, and a network interface controller connected to an IP network.

The server executes system services such as a scheduler (for example, a cron-like scheduling daemon), a web server (for example, a generic HTTP server implementing TLS), and one or more application runtimes such as an interpreter for a scripting language or a virtual machine for an object-oriented language. The server also executes a generative AI model engine, which may be hosted locally or accessed via a network-based inference API. The generative AI model is, in one embodiment, a transformer-based neural network that comprises an embedding layer, multiple self-attention layers, feed-forward layers, and an output projection layer. The neural network parameters are stored in the server's storage and are loaded into memory during inference.

The server uses a digital certificate store, which is typically a directory in a file system, to maintain certificates and associated private keys. The certificates are represented internally as structured objects in memory containing fields such as subject name, issuer name, validity period, and public key material. The server obtains these fields by calling a cryptographic library, for example a library providing X.509 parsing functionality, and by decoding the binary certificate data into an in-memory data structure such as a record or object with typed fields. The server derives a remaining validity period by subtracting a current timestamp from an expiration timestamp and comparing the result with a threshold value stored in configuration.

The server uses the generative AI model to generate prompt sentences that describe, in a machine-readable textual form, desired procedures for certificate renewal, configuration update, and notification behavior. The server forms an input sequence to the generative AI model by concatenating system state information, such as domain names, expiration dates, and paths to configuration files, into a textual context, and by appending a task description. For example, the server may construct a prompt sentence such as:

“Generate a step-by-step procedure to automatically request and install a new TLS certificate for the domain example.com when the remaining validity period is less than 30 days. The procedure should include interactions with a certificate issuing protocol endpoint, updating the HTTP server configuration files, and validating the new certificate without service interruption.”

The server sends the prompt sentence as a sequence of tokens to the generative AI model. The generative AI model converts each token into a vector representation through an embedding layer, applies positional encodings, and processes the sequence through multiple attention blocks. Each attention block computes attention weights over prior tokens, multiplies these weights with corresponding value vectors, and aggregates them to form contextual representations. The generative AI model then uses feed-forward layers and nonlinear activation functions to transform the contextual representations into output vectors, which are mapped back to token probabilities. The generative AI model iteratively samples or selects the most probable tokens to form an output sequence that describes detailed procedures and code-like constructs.

The server parses the output of the generative AI model into structural elements. For example, the server may identify lines indicating shell commands, configuration directives, or logical conditions based on syntactic markers and keyword patterns. The server maps these elements into internal representations such as an abstract task graph, in which each node represents a primitive operation (for example, “invoke certificate protocol client,” “write certificate file,” “reload HTTP server,” or “send notification email”), and edges represent dependencies or ordering constraints. The server thereby transforms free-form natural language into an executable workflow description.

The server uses a workflow engine to store and execute these task graphs. The workflow engine maintains a state machine for each workflow instance, tracking states such as “pending,” “running,” “succeeded,” or “failed.” Each task node is associated with handler functions that call specific system components or external services. For example, a node corresponding to certificate acquisition may call a generic certificate protocol client library that sends requests to a certificate issuing service; a node corresponding to configuration update may modify text-based configuration files according to parsed directives from the AI output; and a node corresponding to notification may send messages through an email service or a messaging interface.

The server uses the generative AI model not only to generate workflows but also to refine them when errors are detected. The server analyzes logs that include error codes, exception messages, and protocol status responses from external services. The server converts these error signals into feature vectors and into textual descriptions. The server then appends them to a new prompt sentence such as:

“The previous automatic certificate renewal workflow failed at the step where the configuration file was reloaded. The error message was: ‘invalid directive in line 42.’ Propose a corrected configuration update procedure that avoids this error.”

The server supplies this prompt sentence to the generative AI model, receives an alternative procedure, and updates the internal workflow graph. This iterative refinement process allows the server to adjust to environment changes and unexpected conditions without manual script editing, thereby improving the resilience and adaptability of the certificate management subsystem.

The server also uses the generative AI model to generate prompt sentences that define how to interact with payment interfaces when an electronic transaction is required to obtain a new certificate. For example, the server may generate or receive a prompt sentence such as: “Provide a sequence of operations that uses a generic payment service interface to authorize and capture a payment for a certificate fee, retries on transient network errors up to three times, and records the transaction identifier for later reconciliation.”

The server uses the generated description to configure an interaction with a payment API. Internally, the server structures payment-related data into records containing fields such as amount, currency, customer identifier, payment method token, and transaction status. The server processes these fields in a deterministic procedure: it constructs a request payload, sends the payload over a secure channel, receives a response, and updates the record fields according to response content. The server logs each transition so that the workflow engine can make decisions, such as whether to proceed to certificate retrieval or to retry after a delay.

The server further uses the generative AI model to generate prompt sentences that describe how to update the configuration of communication control components, such as HTTP servers or reverse proxies. These prompt sentences may specify directives to set certificate file paths, private key paths, supported protocol versions, and cipher suites. The server maps these descriptions into structured configuration objects, which are then rendered into concrete configuration files. Before activating new configurations, the server performs syntax and consistency checks using built-in validation commands provided by the communication control components. Only when these checks succeed does the server issue commands to reload or restart the components. This staged approach reduces the probability of configuration errors that could otherwise interrupt secure communication.

The server uses the generative AI model for notification control. The server collects signals related to user behavior and emotional state, such as frequency and latency of user interactions with management interfaces, patterns in text responses, or feedback selections.

The server transforms these signals into numerical features, for example counts, temporal statistics, and sentiment scores computed by a separate text analysis module. The server includes these features as part of a prompt sentence such as: “Based on a user with high stress score and limited availability, propose a notification policy for certificate expiration warnings that minimizes redundant alerts while ensuring that critical failures are promptly reported. Specify notification priority, medium, frequency, and message style.”

The server parses the resulting description from the generative AI model into a notification policy object that defines rules and thresholds. These include conditions for when to escalate from lower-priority channels to higher-priority channels, how often to repeat warnings, and what level of technical detail to include. The server enforces this policy in the notification subsystem by evaluating the rules against current system events and user state, and by choosing appropriate media (for example, email versus dashboard alert) and content templates.

The terminal, which may be a personal computer, a tablet, or a mobile communication device, accesses the server through secure communication protocols. The terminal sends requests to the server's domain name and validates the server's certificate chain according to trust anchors stored in the terminal's operating system. The terminal thereby uses improved certificate management indirectly, because the server's automated workflows maintain valid certificates without human intervention. The terminal benefits from reduced connection errors, fewer certificate warnings, and more consistent encryption performance.

The user interacts with the generative AI model through a user interface that can run on the server or the terminal. The user may enter prompt sentences directly to request specific workflows or to overrule or refine system-generated behavior. For example, the user may input the following prompt sentences:

“Generate a detailed workflow to migrate existing certificates from one communication control component to another, preserving all security settings and minimizing downtime.” “Explain how to integrate the automatic renewal process with a monitoring system that visualizes certificate status and renewal history.”

“Suggest a notification configuration that sends only high-priority alerts to my mobile device and aggregates low-priority alerts into a daily summary.”

The user reviews the responses, selects appropriate sections, and allows the server to transform them into executable workflows or configuration policies. The user thus collaborates with the generative AI model but is not required to write low-level scripts or configuration files manually.

From a technical perspective, the integration of the generative AI model into the certificate lifecycle management system improves computer technology in several ways. First, the server reduces manual scripting and hard-coded workflows by representing procedures as data structures generated from prompt sentences. This representation allows the server to perform algorithmic optimization, such as reordering tasks to minimize communication latency, caching intermediate results to reduce redundant network calls, or parallelizing independent tasks across processor cores. As a result, certificate issuance and deployment operations can complete faster, and network and processor resources are used more efficiently.

Second, the server improves reliability and accuracy of complex protocol interactions by continuously adapting to observed failures and changes in external interfaces. Rather than relying on a fixed set of hand-crafted rules, the server uses the generative AI model to synthesize alternative procedures based on a wide range of observed patterns encoded in the model's parameters. The server automatically tests and validates these alternatives through configuration checks and controlled execution, which reduces the risk of misconfiguration and failed renewals.

Third, the server enhances data management by structuring internal states such as certificate records, payment transactions, and notification policies into explicit data models. The server uses deterministic algorithms to map between unstructured generative outputs and these structured models, which enables efficient querying, versioning, and rollback of configuration changes. The server can thus maintain an audit trail of certificate and configuration evolution, which is useful for diagnosis and compliance purposes.

Fourth, the server reduces communication overhead by dynamically tuning the number and type of interactions with external services. For example, the server uses the generative AI model to suggest caching rules or batch processing patterns embedded in workflows, such as combining multiple certificate status checks into single requests or scheduling non-urgent updates during periods of low network load. The server implements these patterns as concrete scheduling and batching algorithms, which decreases the overall number of external calls and thus the load on network and remote systems.

The generative AI model itself is trained using a supervised or semi-supervised learning process. The server or a training system constructs a training dataset that includes pairs of input contexts and desired outputs. The input contexts may contain descriptions of system states, error logs, and task goals, while the target outputs may contain known-good procedures, code fragments, and configuration examples. The training system tokenizes both inputs and outputs, feeds them into the transformer-based neural network, and computes a loss function such as cross-entropy between predicted token distributions and target tokens. The training system then updates model parameters using gradient-based optimization such as stochastic gradient descent or adaptive learning-rate methods. The training process may include regularization techniques, such as dropout or weight decay, and data augmentation techniques, such as paraphrasing procedures or varying parameter names, to increase robustness.

By encoding a large variety of certificate management scenarios and error-recovery strategies into its parameter space, the generative AI model enables the server to generate non-trivial workflows that a human operator might not consider. For example, the model may propose to apply specific ordering of domain validation challenges to reduce propagation delays, or to prewarm certain caches before reloading configuration, based on patterns learned from prior data. These non-conventional sequences of operations go beyond simple automation of human workflows and represent an improvement in the way the computer system orchestrates its internal and external components.

In alternative embodiments, the server may use different model architectures, such as recurrent neural networks or encoder-decoder frameworks, as long as the model accepts prompt sentences and emits text used to define workflows and configurations. The server may also combine rule-based components with generative outputs, for example by using a static validation layer that filters or constrains generative suggestions according to safety policies. The server may execute part of the generative processing locally and part remotely, depending on network conditions and computational resources.

In another embodiment, the server may manage multiple types of secure communication endpoints, such as message queues or application programming interfaces, and may coordinate certificates across clusters of machines. The server then uses the generative AI model to produce cluster-wide policies, including consensus procedures for synchronized reloads or phased rollouts. The techniques described above scale to such distributed environments because the workflows are represented as graphs that can be partitioned and assigned to different nodes.

By integrating a generative AI model as a component for synthesizing, refining, and optimizing certificate lifecycle workflows, the server modifies the way in which computer resources are configured and controlled. The server thereby achieves improved processing speed, reduced configuration errors, and enhanced adaptability in response to changing network, protocol, and user conditions.

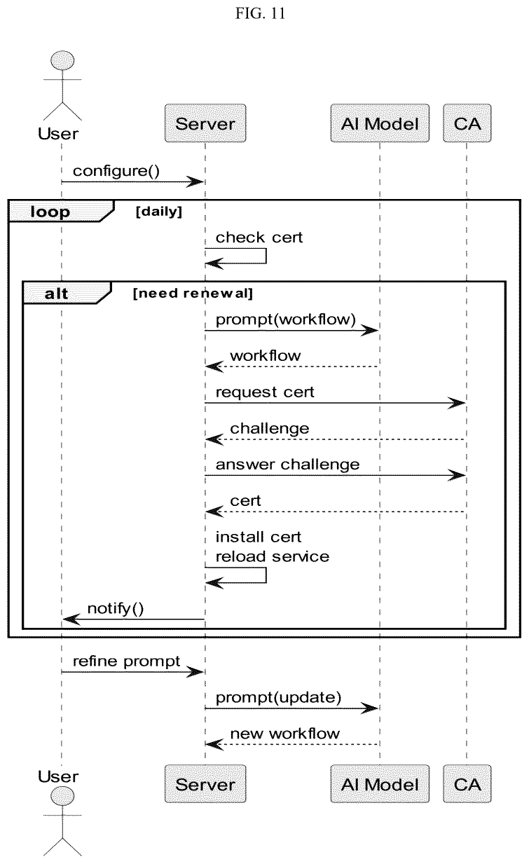

The following describes the processing flow using FIG. 11.

### Step 1:

The server acquires certificate status information. The server reads digital certificate files and associated metadata from a storage resource on the server. As input, the server uses file paths, current system time, and configuration parameters defining a threshold validity period. The server calls a cryptographic library to parse each certificate and extract fields such as subject name, issuer name, and expiration date. The server converts the expiration date string into an internal time representation and subtracts the current time to compute a remaining validity period. As output, the server produces a certificate status record for each certificate, including domain identifier, expiration timestamp, remaining validity period, and a boolean flag indicating whether the certificate is within the threshold.

### Step 2:

The server determines whether automatic renewal is required. As input, the server uses the certificate status records from Step 1 and the configured threshold validity period. The server compares the remaining validity period for each certificate against the threshold and evaluates logical conditions to decide if renewal is needed. The server sets a “needs renewal” flag for each certificate that satisfies the condition and aggregates these flags into a renewal candidate list. As output, the server produces a list of domains and certificate identifiers that require renewal, together with associated configuration data such as existing key locations and protocol endpoints.

### Step 3:

The server constructs a context for the generative AI model. As input, the server uses the renewal candidate list, system configuration information (for example, certificate issuing protocol endpoints, payment interface endpoints, and communication control component types), and historical logs of previous renewals. The server formats these data into a textual description, including domain names, remaining days, and paths to configuration files, and appends a task description to form a prompt sentence. The server may use a prompt sentence such as: “Generate a detailed procedure to automatically request and install a new certificate for the following domains: . . . ”. The server encodes the prompt sentence into tokens as required by the generative AI model. As output, the server generates a tokenized prompt sentence ready for submission to the generative AI model.

### Step 4:

The server invokes the generative AI model to synthesize workflow descriptions. As input, the server supplies the tokenized prompt sentence to the generative AI model. The generative AI model, running on the server or on a remote inference service, performs embedding of tokens into vectors, attention-based context aggregation, and feed-forward transformations to compute output token probabilities. The server controls decoding by iteratively selecting or sampling tokens until an end-of-sequence condition is reached. As output, the server receives a sequence of tokens that it decodes into a natural-language description of processing procedures, configuration changes, and program-like structures for certificate renewal and deployment.

### Step 5:

The server converts the generative output into an internal workflow representation. As input, the server uses the textual description generated in Step 4. The server applies parsing logic, such as pattern matching and rule-based segmentation, to identify procedural steps, conditions, and actions. The server maps these elements into an abstract workflow graph in memory, where nodes represent primitive operations (for example, “send certificate request,” “handle challenge,” “update configuration file,” “reload communication control component,” and “send notification”) and edges represent dependencies and execution order. The server validates the graph for structural consistency and completeness. As output, the server produces a formally structured workflow object that can be stored and executed by a workflow engine.

### Step 6:

The server enriches the workflow with concrete protocol and resource parameters. As input, the server uses the workflow object from Step 5, system configuration data (such as protocol endpoints, API authentication credentials, and file system locations), and certificate-specific parameters (such as domain names and key paths). The server performs parameter binding by associating generic operation descriptors with specific URLs, HTTP methods, JSON field names, file paths, and command options. The server resolves variables and fills in placeholders in the workflow nodes. As output, the server generates an executable workflow instance that is specialized for the current environment and the specific certificates to be renewed.

### Step 7:

The server registers the workflow for scheduled execution. As input, the server uses the executable workflow instance from Step 6 and scheduling policies defined in configuration (for example, execution times, retry intervals, and concurrency limits). The server interacts with a periodic execution control mechanism, such as a scheduling subsystem, by writing entries describing when and how to trigger the workflow. The server records workflow identifiers and scheduling metadata in a management database. As output, the server produces registered tasks that the scheduling mechanism will invoke at appropriate times, ensuring regular monitoring and renewal attempts.

### Step 8:

The server executes the certificate issuing protocol interactions. As input, the server uses the workflow instance, certificate issuing service endpoints, and cryptographic key material. The server sends protocol messages to a certificate issuing service, including requests to initiate issuance and to respond to validation challenges. The server encodes these messages according to the certificate issuing communication protocol and transmits them via the network interface. The server receives responses, decodes them, and updates workflow node states with result codes and challenge data. As output, the server obtains validation statuses, issued certificate data in a structured format, and updated workflow state transitions.

### Step 9:

The server processes validation challenges and resource configuration updates. As input, the server uses challenge information from the certificate issuing service (for example, tokens, required file paths, or resource records), and configuration of local resources such as web document roots and name resolution interfaces. The server writes challenge tokens into specific locations in the file system or calls name resolution interfaces to create or update records. The server performs data processing operations such as string concatenation and encoding to build challenge responses. The server triggers reconfiguration of communication control components if necessary to expose challenge files or records. As output, the server produces updated resource states that satisfy the validation requirements and reports completion of challenge handling back to the workflow engine.

### Step 10:

The server performs electronic transaction processing when payment is required. As input, the server uses payment-related workflow nodes, payment service API information, and stored customer and payment method data. The server constructs payment requests according to payment service specifications, including fields such as transaction amount, currency, and tokenized payment method. The server transmits these requests over secure channels and receives response messages. The server parses responses to extract transaction identifiers, status fields, and error codes, and updates internal transaction records accordingly. As output, the server obtains confirmation of successful payments or error states, and the workflow continues or branches based on these outcomes.

### Step 11:

The server installs and verifies newly obtained certificates. As input, the server uses issued certificate data, existing private key data, and configuration templates for communication control components. The server writes certificate chains and keys to designated storage paths, updates configuration files to reference these paths, and performs validation commands provided by communication control components to verify configuration syntax. The server then triggers reload or restart commands to apply new settings. The server sends test communication requests, such as trial connections, and inspects the returned certificate chain and protocol handshake parameters. As output, the server produces an updated configuration state where new certificates are active and verified, and records success or failure in logs and workflow state.

### Step 12:

The server generates adaptive notification policies using the generative AI model. As input, the server uses information about certificate status, workflow results, and user-related data including inferred emotional state metrics. The server constructs a prompt sentence that summarizes recent events and user context, and submits it to the generative AI model. The generative AI model returns textual descriptions specifying notification timing, priority, medium, and content style. The server parses these descriptions into policy objects, including rule sets for when and how to notify the user. As output, the server obtains machine-readable notification policies that can be evaluated dynamically during subsequent events.

### Step 13:

The server issues notifications based on policy and runtime events. As input, the server uses notification policies from Step 12, current event data (for example, successful renewal, failed validation, or imminent expiration), and contact information for recipients. The server evaluates conditions defined in the notification policies against the event data and user state. The server selects appropriate channels, such as electronic mail or dashboard alerts, and formats messages using predefined templates and variable substitution. The server sends notifications through communication interfaces and records delivery attempts and results. As output, the server produces delivered or queued notifications reflecting system state and user-specific priorities.

### Step 14:

The user interacts with the system to refine workflows and settings. As input, the user receives notifications, dashboards, and explanatory text describing current workflows and certificate status. The user reviews this information and may decide to adjust behavior by entering new prompt sentences into a user interface connected to the generative AI model. For example, the user may input: “Adjust the automatic renewal workflow so that non-critical domains are renewed only during off-peak hours.” The server forwards this prompt sentence to the generative AI model, receives updated procedure descriptions, and reconstructs the workflow representation. As output, the system produces revised workflows and configuration settings that better reflect user preferences.

### Step 15:

The terminal accesses the server's services using the updated certificates. As input, the terminal uses a domain name or network address and the user's request (for example, loading a web page or invoking an application function). The terminal initiates a secure communication handshake and receives the server's certificate chain. The terminal validates the certificate chain against its trust anchors, checks expiration dates, and verifies name matching. The terminal then establishes an encrypted communication channel when checks succeed. As output, the terminal obtains secure access to the server's information services, benefiting from the server's automatic certificate lifecycle management and reduced incidence of certificate errors.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional digital certificate management systems primarily rely on static scheduling and rule-based scripts that periodically check certificate expiration dates and, in some cases, trigger automated renewal workflows. However, such systems exhibit several technical limitations from the perspective of computer technology.

First, traditional systems tend to treat expiration management, transaction processing, certificate deployment, and user notification as separate, loosely coupled components. As a result, state information regarding certificate validity, transaction results, and configuration update status is dispersed across multiple logs, configuration repositories, and service instances. This fragmentation increases the complexity of maintaining consistent state within the computing environment, raises the probability of configuration drift, and complicates automated reasoning about when and how the system should react to impending expiration or deployment failures.

Second, existing solutions often embed fixed message templates and simple conditional logic for user notifications, which are disconnected from the actual internal state of the system. These notifications are typically generated without reflecting the user's current emotional state, usage context, or the detailed system state regarding certificate lifecycle events. This mismatch leads to either excessive, low-value alerts or insufficient, overly technical messages. From a computer-technical standpoint, this results in suboptimal scheduling and prioritization of background tasks and notification workflows, causing unnecessary load on processing resources and communication interfaces, and increasing latency in reacting to critical events.

Third, known systems do not leverage generative AI models as first-class components within the internal control flow of certificate lifecycle management. Generative AI models, if used at all, are typically applied only as external assistants for human operators and not as programmable mechanisms that transform structured internal state information into dynamically generated control directives. As a consequence, computer systems are unable to flexibly adjust complex multi-step workflows-such as coordinating certificate issuance, electronic transaction processing, and configuration deployment-based on rich, structured state information, while still presenting the results in a form that is both machine-actionable and suitable for human-readable notification.

Fourth, conventional architectures generally fail to unify the generation of machine-oriented control instructions and human-facing notification messages under a common representation. Rule-based engines produce procedural scripts for operations, while fixed templates produce natural language notifications, leading to duplicated logic, inconsistent behavior, and increased maintenance overhead. This separation hinders the ability of the computer system to adapt the content, priority, and timing of notifications in response to dynamically changing system states and user conditions, and prevents the system from optimizing resource allocation for background tasks and communication channels based on contextual information.

Fifth, the deployment of renewed certificates onto service-providing information processing apparatuses, including web servers or application servers, is frequently handled by ad hoc scripts and manual procedures. These mechanisms lack a standardized way to expose certificate lifecycle state, transaction results, and configuration update results as structured data that can be consumed by external terminals or higher-level orchestration logic. This deficiency makes it difficult to build reliable, scalable, and interoperable management layers that can oversee multiple certificate-managed services across distributed computing environments.

Accordingly, there is a need for an improved computer-implemented system that: (i) maintains unified, structured state information for digital certificate lifecycle events; (ii) tightly integrates automated certificate acquisition, electronic transaction processing, and configuration deployment; (iii) uses generative AI models to generate prompt sentences that serve both as internal control instructions and as bases for user-facing notification content; (iv) dynamically adjusts notification timing, priority, and content based on user emotional state and usage context; and (v) exposes service state in a structured, machine-consumable format. Such a system would improve the operation of computers themselves, by reducing configuration inconsistencies, optimizing background processing and communication flows, and enabling more adaptive and context-aware control over certificate management and related notification workflows.

The specific processing by the specific processing unit 290 of the data processing device 12 in Application Example 1 is realized by the following means.

The present invention provides a server comprising a processor configured to obtain validity period information for cryptographic communication authentication information, calculate a remaining validity period based on a comparison between the validity period information and current time information, generate state information indicating that the remaining validity period is less than or equal to a predetermined threshold, and generate, by using a generative AI model, a prompt sentence that instructs initiation of an update process for the cryptographic communication authentication information based on the state information; to generate, based on the state information, secret information and signature request information corresponding to the cryptographic communication authentication information, to automatically perform an acquisition request for new cryptographic communication authentication information by transmitting the signature request information through a cryptographic communication authentication information issuing communication interface, to automatically complete transaction processing related to acquisition of the cryptographic communication authentication information by executing electronic settlement processing through a settlement communication interface, to store the acquired cryptographic communication authentication information as configuration information of a service providing information processing apparatus, to update communication control settings of the service providing information processing apparatus so as to apply the cryptographic communication authentication information, and to generate, by using the generative AI model, a prompt sentence that instructs the storing, the updating, and the transaction processing; to acquire user state information including usage situation information and biometric reaction information from at least one of the service providing information processing apparatus and a portable information processing apparatus, to analyze an emotional state of a user based on the user state information, to determine notification content, a notification priority, and a notification execution time in accordance with the emotional state, the state information, transaction processing result information, and setting update result information, and to generate, by using the generative AI model, a prompt sentence that instructs presentation of a notification message to the portable information processing apparatus in accordance with the determination result; to output, as structured data, management information including the state information, the transaction processing result information, and the setting update result information in response to an acquisition request from an external terminal so as to provide a service state; and to receive the structured data as input information and generate, by using the generative AI model, a prompt sentence that instructs generation, based on the input information, of an explanatory text that describes, in natural language, a management state, an update history, and a future update schedule of the cryptographic communication authentication information. This enables the computer system to maintain unified and machine-consumable state information for certificate lifecycle events, to autonomously coordinate certificate acquisition, electronic transaction processing, and configuration deployment, and to adapt internal control flows and user-facing notification behavior based on dynamically changing technical state and user emotional state, thereby improving reliability, scalability, and resource efficiency in digital certificate management and associated notification processing.

The term “cryptographic communication authentication information” refers to electronic information used in a communication system to authenticate a communication party and to establish an encrypted communication channel, including for example a digital certificate, a public key, and associated metadata.

The term “validity period information” refers to data indicating a start time and an end time during which cryptographic communication authentication information is considered valid for use in a communication system.

The term “remaining validity period” refers to a time interval calculated by subtracting a current time from an end time indicated by validity period information of cryptographic communication authentication information.

The term “state information” refers to structured data representing a condition of cryptographic communication authentication information, including at least whether a remaining validity period is less than or equal to a predetermined threshold and whether associated processing has succeeded or failed.

The term “predetermined threshold” refers to a time value, defined in advance by configuration or policy, used as a criterion to determine whether a remaining validity period of cryptographic communication authentication information is considered close to expiration.

The term “generative AI model” refers to a machine learning model configured to generate text or other content in response to an input, including at least a neural network-based language model that outputs natural language or structured instructions based on a prompt sentence.

The term “prompt sentence” refers to a text string provided as input to a generative AI model, the text string describing a requested operation, desired output characteristics, or contextual information to guide generation by the generative AI model.

The term “secret information” refers to confidential data used in cryptographic processing, including for example a private key associated with cryptographic communication authentication information.

The term “signature request information” refers to data used to request issuance of cryptographic communication authentication information from an issuing entity, including at least a public key and identification information of a communication endpoint.

The term “cryptographic communication authentication information issuing communication interface” refers to a communication interface used by a server to send and receive data with an issuing apparatus or service that issues cryptographic communication authentication information.

The term “settlement communication interface” refers to a communication interface used by a server to perform electronic settlement processing with a transaction processing apparatus or service.

The term “transaction processing” refers to processing for executing an electronic transaction required to acquire or maintain cryptographic communication authentication information, including at least payment authorization, payment capture, or subscription management.

The term “service providing information processing apparatus” refers to an information processing apparatus configured to provide an information service to an external terminal by using cryptographic communication authentication information in a communication control process.

The term “communication control settings” refers to configuration information used by a service providing information processing apparatus to control secure communication, including at least protocol settings, key and certificate file paths, and security policy parameters.

The term “portable information processing apparatus” refers to a transportable information processing device configured to execute an application program and to present information to a user, including for example a smartphone or a tablet terminal.

The term “usage situation information” refers to information indicating how a user uses an information service or a portable information processing apparatus, including for example access frequency, operation history, and application usage context.

The term “biometric reaction information” refers to information related to a physical or physiological reaction of a user, acquired by a sensor or an input operation, and usable to estimate an emotional state of the user.

The term “user state information” refers to information representing a condition of a user, including at least usage situation information and biometric reaction information.

The term “emotional state” refers to a psychological state of a user, such as calmness, anxiety, or urgency, inferred from user state information by an analysis process.

The term “notification content” refers to information to be included in a notification message presented to a user, including at least a summary of system state, a warning, or recommended user actions.

The term “notification priority” refers to a level indicating importance or urgency of a notification message, used to control ordering, emphasis, or delivery behavior of notifications.

The term “notification execution time” refers to a point in time or time period at which a system is configured to present or transmit a notification message to a user.

The term “notification message” refers to information output to a user via a portable information processing apparatus, the information including at least text generated or instructed based on processing by a generative AI model.

The term “management information” refers to structured data that collectively represents a lifecycle state of cryptographic communication authentication information, including at least state information, transaction processing result information, and setting update result information.

The term “transaction processing result information” refers to information indicating an outcome of transaction processing, including at least a success or failure status, an error code, or a transaction identifier.

The term “setting update result information” refers to information indicating an outcome of updating communication control settings or configuration information of a service providing information processing apparatus.

The term “structured data” refers to data organized in a predefined format, such as a record, table, or hierarchical structure, enabling programmatic access and processing by an external terminal or service.

The term “external terminal” refers to a computing device separate from a server that requests acquisition of management information or service state, including for example a management console device or another network-connected apparatus.

The term “service state” refers to information indicating an operational state of an information service provided by a service providing information processing apparatus, including at least availability, security status, and certificate lifecycle status.

The term “explanatory text” refers to a natural language description generated based on structured data, the description explaining a management state, an update history, or a future update schedule of cryptographic communication authentication information.

The term “update history” refers to information indicating past events related to cryptographic communication authentication information, including at least issuance, renewal, replacement, and failure events.

The term “future update schedule” refers to information indicating a planned timing or period for a future update or renewal of cryptographic communication authentication information.

The term “notification content optimization policy” refers to a set of rules or parameters that define how to adjust at least a technical detail level, an expression difficulty level, and a message length of a notification message based on user-related and system-related information.

In one embodiment, a server, a terminal, and a user cooperate to implement a system for managing cryptographic communication authentication information, such as digital certificates used for secure network communication. The server executes a program on computing hardware that includes at least one processor, a memory, a nonvolatile storage device, and one or more network interfaces. The terminal executes a client application on a portable information processing apparatus, such as a smartphone or a tablet device. The user operates the terminal to receive notifications and optionally adjust configuration parameters. The server operates on hardware such as a general-purpose computing device or a virtual machine instance running an operating system, for example a Unix-like operating system. The server uses server software such as an HTTP server for providing an information service (for example, a web service) and an application execution environment such as a scripting language runtime. The server also uses a cryptographic library, such as a library for processing X.509 certificates and Transport Layer Security (TLS) parameters, to parse certificates, compute expiration times, and verify key-certificate consistency. The server stores certificate-related data structures in a persistent database. The server, for example, uses a relational database management system and an object-relational mapping library. The server maintains, in at least one database table, records for each managed cryptographic communication authentication information, including: a domain identifier, a certificate serial number, validity period information (start time and end time), a remaining validity period field, state information flags (such as “expiring_soon,” “order_created,” “payment_completed,” and “install_completed”), and references to file paths where associated key material and certificates are stored. The server further maintains records for transaction processing results, including transaction identifiers, status codes, and timestamps, as well as records for configuration update results that indicate success or failure of updating communication control settings.

The server uses a scheduler mechanism, such as a task scheduler or background job manager, to initiate internal analysis and update operations. The server retrieves validity period information from stored certificate files or from certificate records in the database. The server converts validity period information into normalized time representations, for example, a 64-bit integer representing Unix time in seconds, and computes a remaining validity period by subtracting the current system time from the certificate expiration time. The server updates the remaining validity period field in the database and sets or resets state information flags based on a comparison with a predetermined threshold value, such as a configurable number of days. This comparison is implemented as arithmetic and logical operations on integer representations, improving calculation speed and reducing floating-point rounding errors. The server uses a specialized data structure to represent state information as a bit field or as an enumerated type, in order to compress multiple status dimensions into a compact representation. For example, the server maps different states—such as “expiration soon,” “order pending,” “payment failed,” and “installation succeeded”—to individual bits in a 32-bit integer, and uses bitwise logical operations to update and query these states. This approach reduces memory usage, speeds up state queries in the database, and enables rapid evaluation of complex logical conditions required for controlling the certificate lifecycle. The server generates secret information and signature request information by using the cryptographic library. The server generates a key pair, such as an RSA key pair or an elliptic curve key pair, with specified key length or curve parameters. The server stores a private key in a restricted directory on a storage device, with file system permissions limiting access to operating system-level service accounts. The server generates signature request information in the form of a certificate signing request structure that includes a public key, a distinguished name for the subject, and optional subject alternative names. The server encodes this structure in a standardized format and updates the database with references to the new key and request data.

The server uses a cryptographic communication authentication information issuing communication interface to communicate with an issuing apparatus or service. The server composes request messages in a structured format, such as JavaScript Object Notation (JSON), embedding the encoded certificate signing request and additional metadata, such as contact information and policy identifiers. The server transmits these request messages over a secure communication channel, for example a TLS-encrypted HTTP connection, to an external issuance endpoint. The server receives response messages, parses structured fields such as order identifiers and challenge information, and updates the state information fields in the database accordingly.

The server uses a settlement communication interface to perform electronic settlement processing. The server transmits transaction information, such as an amount, currency, and order identifier, to an external transaction processing service over a secure communication channel. The server receives transaction results, such as a status code indicating “succeeded” or “failed” and an associated transaction identifier. The server records these results in a transaction processing result information table and updates the corresponding flags in the state information bit field. This design allows the server to tightly couple cryptographic communication authentication information acquisition with transaction processing, avoiding inconsistent states where a certificate is ordered but payment has not been completed. The server obtains newly issued cryptographic communication authentication information from the issuing interface, decodes the received certificate or certificate chain, and writes the data to storage devices at predetermined file paths associated with the service providing information processing apparatus. The server verifies that the issued certificate matches the stored private key by performing verification operations with the cryptographic library. The server updates communication control settings of the service providing information processing apparatus, for example by modifying configuration files that specify certificate and key file paths and protocol parameters. The server then triggers a controlled reload of the service software, such as signaling a web server process to reload configuration without interrupting active connections. This close integration between certificate retrieval, verification, and configuration update reduces the risk of deployment errors and service downtime.

The server maintains management information as structured data that correlates the state information, the transaction processing result information, and the setting update result information. The server exposes a service state interface via a web-based application programming interface, allowing external terminals, such as administrator consoles or monitoring systems, to obtain up-to-date status for each certificate-managed service. The server serializes management information into structured representations, such as nested objects or relational result sets, and transmits them over secure communication channels. This structured representation enables external components to perform automated reasoning and visualization without needing direct access to internal file systems or logs.

The server employs a generative AI model to generate prompt sentences. In one embodiment, the server or the terminal uses a neural network-based language model, such as a transformer model with multiple self-attention layers, token embeddings, and positional encodings. The generative AI model may have been pre-trained on large-scale text data using an unsupervised language modeling objective that minimizes a cross-entropy loss between predicted and actual token sequences. The model parameters are optimized through gradient-based learning using an algorithm such as stochastic gradient descent with adaptive learning rate adjustment. In some embodiments, the generative AI model is further fine-tuned on domain-specific text data related to security notifications and operational procedures, thereby improving the relevance and clarity of generated outputs.

The server or the terminal creates a prompt sentence as input to the generative AI model. The server constructs the prompt sentence by mapping structured management information to a textual representation. For example, the server converts the domain identifier, remaining validity period, and flags representing transaction and installation status into descriptive phrases, and concatenates them with explicit instructions specifying desired output style and length. The following are examples of such prompt sentences:

“You are a generative AI model that creates clear, reassuring notifications for non-technical users. The SSL certificate for example.com was renewed automatically before expiration, payment was completed, and the new certificate has been installed on the server. Please write a short notification message (under 40 words) informing the user that everything is up to date and no action is required.”

“You are a generative AI model that explains technical issues in simple language. The SSL certificate for example.com could not be renewed automatically because the payment failed. Please generate a short notification message asking the user to check their payment information and contact support if needed.”

“The SSL certificate for example.com will expire in 25 days. The server has automatically ordered a new certificate, completed the payment, and successfully installed the new certificate. Please generate a short, reassuring notification message for a non-technical user, explaining that everything is up to date and no action is required.”

The terminal receives management information or summarized status data from the server. The terminal executes a client application that parses the structured data and assembles prompt sentences according to a notification content optimization policy. The terminal calls the generative AI model via a network-accessible inference service or via an embedded model execution engine. The terminal specifies parameters such as maximum token length, temperature, and output style constraints to control the generation process. The terminal receives the generated text output, which constitutes a candidate notification message. The terminal adjusts the generated notification message in accordance with display constraints and user preferences. For example, the terminal truncates messages that exceed a certain length, or adds device-specific header text. The terminal uses an operating system notification framework to present the notification message on a display. The terminal can also store the generated messages in a local database or cache, allowing the user to open a history view that shows past notifications and corresponding certificate lifecycle events. The server acquires user state information by integrating with sensing inputs and usage logging components. The server or the terminal collects usage situation information, such as the frequency of accessing the information service, typical access times, response times, and patterns of interaction with security-related dialogs. The server or the terminal collects biometric reaction information, such as heart rate variations, touch pressure, or accelerometer data, provided that appropriate sensors and user consents are in place. The server processes these signals into feature vectors, including time-series summaries, statistical measures, and derived indicators (such as high engagement, low engagement, or stress likelihood). The server or the terminal uses a machine learning-based emotional state estimation component to infer an emotional state from the user state information. This component can be implemented as a neural network or other classifier trained on labeled datasets that map combinations of usage situation features and biometric features to categories such as “calm,” “neutral,” “concerned,” or “stressed.” The inference process results in an emotional state label and a confidence score. The server stores this information temporarily or aggregates it into longer-term behavioral profiles, subject to privacy constraints.

The server determines notification content, notification priority, and notification execution time based on the emotional state, the state information, the transaction processing result information, and the setting update result information. For example, when the emotional state indicates high stress and the remaining validity period is still long, the server may lower notification priority or delay non-critical updates to avoid overburdening the user interface. Conversely, when the emotional state indicates calmness and a certificate is close to expiration or a transaction has failed, the server may elevate the notification priority and schedule prompt notifications. This dynamic scheduling improves resource utilization by grouping notifications and background operations when the system detects reduced user activity, thereby lowering peak processing loads and network traffic.

The server generates prompt sentences that encode these determinations in a machine-readable yet model-oriented textual format. The server uses the generative AI model not only for generating final notifications, but also for synthesizing intermediate control directives. For example, the server can construct prompt sentences that specify which background tasks should be scheduled, how to compress event histories into short explanations, or how to select technical detail levels appropriate for user expertise and emotional state. The generative AI model then returns control sequences or text fragments that the server parses into structured directives. This non-traditional usage of a generative AI model as an internal decision support module provides a flexible means of orchestrating complex control flows without embedding rigid, hard-coded rule trees.

Because the server converts internal structured state into compact textual prompts and then processes the generated textual directives back into structured instructions, the system reduces redundancy between machine-operation logic and user-facing messaging logic. The same underlying generative AI model can produce both user-friendly explanations and machine-actionable text that is parsed into control commands or configuration suggestions. The server employs deterministic parsing patterns for recognized tokens, ensuring that generated outputs can be transformed into reliable internal actions, while still benefiting from the generative model's ability to synthesize nuanced responses. This architecture is not a mere automation of human administrative tasks; it re-organizes how the computer system internally represents and processes control policies, enabling adaptive reconfiguration and enabling optimization of the scheduling of operations, thereby improving processing efficiency and reducing configuration errors.

The technical effect of this design appears in several aspects. The server reduces the number of failed renewals and misconfigurations by tightly coupling the certificate lifecycle state, transaction processing results, and deployment outcomes into a unified state representation that is actively consumed by downstream processes and the generative AI model. The server improves processing speed by using compact state representations and limiting redundant external calls. The server reduces network and storage overhead by encoding complex event histories into short, context-aware explanatory texts rather than transmitting raw log data. The server enhances accuracy in notification timing and content by incorporating emotional state estimations and usage patterns, which cannot be practically modeled by simple rule-based systems.

The terminal, by leveraging the generative AI model to produce notification messages that reflect both detailed internal state and user context, reduces the need for repeated user queries and support requests, thereby decreasing server load associated with diagnostic operations. The use of transformer-based generative AI models, or other neural architectures, with trained parameters and defined loss functions, demonstrates that the system performs nontrivial computational work to transform structured internal state into optimized messages and control instructions. These operations go beyond generic data retrieval and display; they enhance the functioning of the underlying computing infrastructure by improving how and when computational tasks are initiated, merged, or deferred.

In alternative embodiments, the generative AI model can run locally on the server, on the terminal, or on a dedicated inference device, such as a specialized accelerator. The server can employ different neural network architectures, including recurrent networks or convolutional networks, depending on resource constraints and performance requirements. The server can also use alternative cryptographic libraries or certificate issuance protocols, as long as the server maintains the structured management information and the integrated control flow described above. The terminal can implement distinct user interface components, such as dashboards, widgets, or voice-based assistants, to render the notification messages generated based on the prompt sentences. The user can configure various parameters, such as the predetermined threshold for remaining validity period, the granularity of notification categories, or preferences regarding technical detail levels.

The server and the terminal thus cooperate to form a system that leverages generative AI models and structured internal state representations to manage cryptographic communication authentication information in a way that improves computational resource usage, reliability, and responsiveness of the underlying computer technology, rather than merely automating pre-existing human-centric procedures.

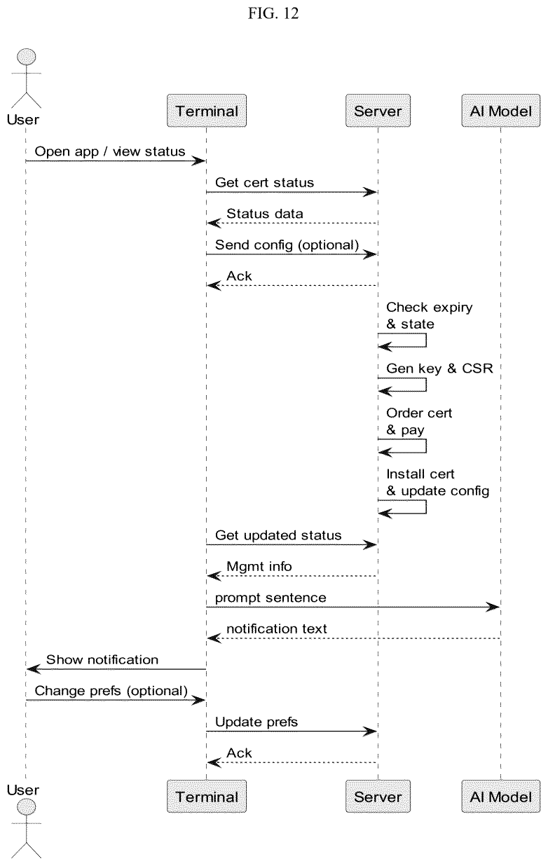

The following describes the processing flow using FIG. 12.

### Step 1:

The server acquires certificate metadata and initializes state.

The server receives, as input, existing cryptographic communication authentication information and associated configuration data stored in a database and file system, including a certificate file, a domain identifier, and previous state flags. The server reads the certificate file using a cryptographic library, parses fields such as the “NotBefore” and “NotAfter” timestamps, and converts these values into normalized time representations (for example, Unix time in seconds). The server writes or updates database records to store the parsed validity period information and resets transient state flags such as “renewal_in_progress.” As output, the server produces a normalized certificate record that includes domain, validity period, and an initialized state information field.

### Step 2:

The server calculates the remaining validity period and updates state information. The server receives, as input, the normalized certificate record containing validity period information and the current system time obtained from the operating system clock. The server computes the remaining validity period by subtracting the current time from the certificate expiration time, and it converts the result into an integer number of days. The server compares this remaining validity period to a predetermined threshold value stored in a configuration table. Based on this comparison, the server updates a state information field (for example, a bit field or status column) to indicate whether the certificate is “expiring soon.” As output, the server produces updated state information, including a flag that indicates whether renewal should be initiated.

### Step 3:

The server decides whether to initiate the renewal workflow.

The server receives, as input, the updated state information for one or more certificates, including the “expiring soon” flag and any existing “renewal_in_progress” markers. The server performs a logical evaluation by checking whether “expiring soon” is true and “renewal_in_progress” is false. If both conditions are satisfied, the server sets “renewal_in_progress” to true and constructs an internal task descriptor that references the domain and certificate record. The server stores the modified state in the database and enqueues the task descriptor into a background job queue managed by a task scheduler. As output, the server produces an active renewal task entry that can be consumed by subsequent processing modules.

### Step 4:

The server generates secret information and signature request information.

The server receives, as input, the active renewal task entry specifying a domain and associated certificate record. The server invokes a cryptographic library to generate a new key pair with specified parameters (for example, RSA key length or elliptic curve type). The server stores the private key file in a secure directory with restricted permissions and uses the public key and domain information to construct certificate signing request data. The server encodes this request data in a standardized format and writes it to storage while also updating database fields that reference the key and request. As output, the server produces a set of cryptographic artifacts, including a private key, a public key, and a certificate signing request linked to the renewal task.

### Step 5:

The server communicates with a certificate issuing interface to request a new certificate. The server receives, as input, the certificate signing request, domain identifier, and relevant account credentials for the issuing service. The server composes a structured request message that includes the encoded certificate signing request and any required metadata. The server sends this message through a cryptographic communication authentication information issuing communication interface via a secure network connection. The server receives a response message containing an order identifier and an initial order status, parses the response fields, and records the order identifier and status in the database. As output, the server produces an updated renewal task record that associates the domain with an active issuance order.

### Step 6:

The server performs electronic transaction processing for the certificate acquisition. The server receives, as input, the updated renewal task record, including the order identifier and pricing information configured for the certificate type. The server constructs transaction data containing an amount, currency, and order reference, and sends this data through a settlement communication interface to an external transaction processing system over a secure link. The server receives, as output from the external system, a transaction result that includes a status code and a transaction identifier. The server parses this result and updates a transaction processing result information field in the database, setting flags such as “payment_completed” or “payment_failed.” As output, the server produces a consistent record linking the certificate order with the transaction status.

### Step 7:

The server retrieves the issued certificate and deploys it to the service providing information processing apparatus.

The server receives, as input, the order identifier and transaction processing result information. When the payment status indicates success, the server periodically queries the issuance service via the certificate issuing interface, using the order identifier, until the order status indicates that the certificate has been issued. The server then downloads the certificate data and certificate chain, decodes them, and writes the certificate files to preconfigured paths on the storage device used by the service providing information processing apparatus. The server uses the cryptographic library to verify that the new certificate matches the stored private key. The server updates communication control settings, such as configuration files for a web or application server, and triggers a controlled reload or restart so that the new certificate takes effect. As output, the server produces a setting update result information field indicating success or failure of the deployment.

### Step 8:

The server consolidates lifecycle data into structured management information.

The server receives, as input, multiple fields from the certificate record, including state information, transaction processing result information, and setting update result information. The server aggregates these components into a structured management information object that also includes fields such as domain, validity period, remaining validity period, and timestamps of key events. The server serializes this object into a representation suitable for external transmission, such as a structured record or a nested object. As output, the server produces machine-consumable management information ready to be delivered to terminals or external terminals.

### Step 9:

The server provides service state information to external terminals.

The server receives, as input, an acquisition request from an external terminal, which may specify a domain or account identifier. The server queries the database using this identifier to retrieve the corresponding structured management information. The server applies any necessary access control checks and filters sensitive fields, then serializes the management information into a response message. The server sends this response message over a secure network connection to the requesting external terminal. As output, the server delivers a current service state representation that external components can use for monitoring or administration.

### Step 10:

The server generates a prompt sentence for internal explanatory text creation.

The server receives, as input, the structured management information that describes the current and historical state of the cryptographic communication authentication information. The server converts selected fields—such as the domain, remaining validity period, transaction status, and update history—into a textual description, and then appends explicit instructions describing the desired explanatory style and level of detail. The server thus constructs a prompt sentence suitable for a generative AI model. The server transmits this prompt sentence to a generative AI model interface and receives an output text that serves as a natural language explanatory text. As output, the server produces both the prompt sentence and the generated explanatory text, which can be stored or passed to other modules.

### Step 11:

The terminal acquires status and management information from the server.

The terminal receives, as input, a user identifier or configuration indicating which domains or services the user is associated with. The terminal sends a request message to the server's service state interface, including appropriate authentication tokens. The terminal receives a response message containing structured management information for one or more domains. The terminal parses this structured data, extracting fields such as remaining validity period, transaction results, and deployment status. As output, the terminal produces a localized snapshot of the server-side status that can be used for notification and display.

### Step 12:

The terminal constructs a prompt sentence for notification message generation.

The terminal receives, as input, the localized snapshot of management information and, optionally, user preference and emotional state information. The terminal selects or derives a notification content optimization policy based on this input, determining, for example, whether to use a technical or non-technical tone and how long the message should be. The terminal then maps key management information fields into a textual template and appends instructions about tone, length, and clarity, thereby forming a prompt sentence targeted at a generative AI model. As output, the terminal produces a prompt sentence that encodes both the system state and the desired characteristics of the notification.

### Step 13:

The terminal invokes a generative AI model to produce a notification message.

The terminal receives, as input, the constructed prompt sentence and configuration parameters for the generative AI model, such as maximum length and temperature. The terminal sends this prompt sentence to a generative AI model execution environment accessible via a network or locally on the device. The generative AI model processes the prompt sentence and outputs a candidate notification message in natural language. The terminal receives this output text and optionally performs post-processing, such as truncation or insertion of device-specific labels. As output, the terminal obtains a finalized notification message text suitable for user presentation.

### Step 14:

The terminal presents the notification message to the user.

The terminal receives, as input, the finalized notification message and metadata such as priority and suggested display time. The terminal schedules or immediately displays a notification via the operating system's notification framework, presenting the message on the device display and optionally associating it with an action that opens a detailed status view in the client application. The terminal records the display event and, if the user interacts with the notification, opens the application to show detailed certificate lifecycle information. As output, the terminal produces a visual representation of the notification to the user and updates local interaction logs.

### Step 15:

The user reviews notifications and optionally modifies configuration settings.

The user receives, as input, the displayed notification message on the terminal and interprets its content, such as confirmation that a certificate has been renewed or a warning that a payment has failed. The user, based on the message, may open the client application's configuration interface and change parameters such as the threshold for “expiring soon” or the desired level of technical detail in messages. The user confirms these changes through the application's user interface. As output, the user produces updated configuration preferences that the terminal transmits to the server.

### Step 16:

The server updates configuration and influences subsequent processing.

The server receives, as input, an update request from the terminal containing modified configuration parameters, such as a new threshold for remaining validity period or revised notification policies. The server validates these parameters and writes them into configuration tables in the database. The server adjusts internal logic that evaluates remaining validity periods, sets state information flags, and constructs prompt sentences in subsequent cycles, based on the new configuration. As output, the server produces updated configuration records that directly affect how future data processing and control decisions are made in the certificate lifecycle management workflow.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented certificate management systems generally employ static scripts or fixed rule sets to periodically check the validity of digital certificates and to send simple alert messages to administrators when an expiration date is approaching. While such approaches can detect some expiration events, they suffer from several technical limitations. First, the monitoring logic is typically decoupled from notification generation, so that the system merely produces raw date differences without intelligently tailoring the notification content, timing, or channel to current system conditions. As a result, administrators may receive overly frequent, poorly structured, or context-insensitive alerts, which can lead to alert fatigue, delayed responses, and an increased risk that a critical certificate will inadvertently expire.

Second, existing systems rarely use machine-learning-based text generation in a structured way to assist downstream automated processing. Notifications are usually handcrafted or hard-coded, and cannot easily be adapted to different services, policies, or administrator preferences without manual reconfiguration and code changes. This limits scalability and makes it difficult to maintain consistency of notification content across heterogeneous information services and environments.

Third, conventional systems generally do not exploit user state, such as an estimated emotional state or workload condition of the human operator, as an input signal to control notification behavior. In many environments, multiple certificate-related and non-certificate-related alerts compete for the administrator's attention. Without any model of user context, the system may deliver urgent and non-urgent notifications through the same channel and at similar times, thereby degrading the effectiveness of the most critical alerts and making the overall computing environment less reliable.

Fourth, digital certificate expiration can cause abrupt termination of secure channels or disruption of electronic transactions, which may directly affect availability of information-providing services and the integrity of transaction flows. When detection, notification, and remediation are loosely coupled, there is often no end-to-end mechanism by which the system can both (i) drive the acquisition and installation of updated certificate information and (ii) orchestrate the steps necessary to complete pending or scheduled electronic transactions in a timely manner. This fragmented architecture can require manual intervention across several tools and applications, which increases latency and error probability in the certificate renewal process.

Accordingly, there is a need for an improved computer-implemented system that integrates (i) automated determination of certificate approaching-expiration states, (ii) generation of machine-interpretable prompt sentences using a generative AI model for controlling update and notification operations, and (iii) adaptive control of notification timing, content, and delivery channels based on both system state and user emotional state. Such a system should technically improve the way an information processing apparatus monitors and maintains certificate validity, reduce the likelihood of service interruption caused by certificate expiration, and enhance the efficiency and reliability of computer-based notification handling and transaction completion.

The specific processing by the specific processing unit 290 of the data processing device 12 in Example 2 is realized by the following means.

The present invention provides a server comprising a processor configured to monitor validity-period information of electronic certificate information corresponding to a plurality of information-providing services connected via a communication path, by activating a certificate-information acquisition program, externally invoking software having cryptographic processing functionality, acquiring the validity-period information output from the software, calculating a remaining validity period of the electronic certificate information by using the validity-period information and system-time information, and determining an approaching-expiration state by comparing the remaining validity period with a predetermined threshold; to generate, when the approaching-expiration state is determined, a first prompt sentence including at least one piece of identification information corresponding to the electronic certificate information, expiration date information, and remaining validity-period information as input information, to input the first prompt sentence into a generative AI model, to cause the generative AI model to generate a second prompt sentence for instructing at least one of an update operation and a notification operation relating to the electronic certificate information, and to acquire the second prompt sentence; to generate and transmit, based on the second prompt sentence, an electronic communication message to a management terminal by using software having electronic communication-processing functionality, and to display notification information indicating the approaching-expiration state of the electronic certificate information on a management screen having display-control functionality; to cause, based on the second prompt sentence, external software to execute an acquisition process of new electronic certificate information and a setting process of the acquired electronic certificate information in an information processing apparatus, and to cause an external program to execute procedure processing necessary for completing an electronic transaction process that depends on the electronic certificate information; and to estimate a user emotional state by analyzing user-attribute information and emotional-state estimation information, to generate a third prompt sentence including at least one of the emotional state and the approaching-expiration state as input information, to input the third prompt sentence into the generative AI model, to cause the generative AI model to generate a fourth prompt sentence for adjusting at least one of a notification timing and notification content, and to control the notification timing and the notification content based on the fourth prompt sentence. This enables technical improvement of computer-based certificate lifecycle management by tightly coupling automated expiration detection with machine-generated control prompts, by adaptively generating notification messages and update instructions suitable for different services and administrator contexts, by reducing occurrences of service interruption due to certificate expiration, and by optimizing notification priority and delivery according to both system state and user emotional state within the computing environment.

The term “electronic certificate information” refers to digital data representing a credential, including at least a public key and associated attribute information, that is used by an information processing apparatus to authenticate a communication counterpart or to establish a secure communication channel.

The term “validity-period information” refers to information included in or associated with electronic certificate information that specifies at least a start time and an end time during which the electronic certificate information is to be treated as valid.

The term “remaining validity period” refers to a temporal interval computed by a processor based on validity-period information and current system-time information, indicating a remaining duration until expiration of the electronic certificate information.

The term “approaching-expiration state” refers to a state determined by comparing the remaining validity period with a predetermined threshold, indicating that the remaining validity period is equal to or less than the threshold and that expiration of the electronic certificate information is imminent.

The term “information-providing service” refers to a computer-implemented service, accessible via a communication path, that supplies information or processing results to a user or another system, and that relies on electronic certificate information for secure communication or authentication.

The term “communication path” refers to a logical or physical transmission route, including at least one of a wired network, a wireless network, or a combination thereof, through which data is exchanged between an information processing apparatus and an external device or service.

The term “certificate-information acquisition program” refers to program code executable by a processor that causes the processor to request, receive, and process electronic certificate information or validity-period information from an external device, service, or software component.

The term “software having cryptographic processing functionality” refers to a software component or module capable of performing at least one of encryption, decryption, digital signature processing, certificate parsing, or certificate validation.

The term “system-time information” refers to time-related data obtained from a clock function of an information processing apparatus, indicating at least a current date and time used as a reference in computation of the remaining validity period.

The term “predetermined threshold” refers to a temporal value, specified in advance by configuration or program logic, that is used as a reference boundary when determining whether the remaining validity period constitutes an approaching-expiration state.

The term “prompt sentence” refers to a machine-interpretable text sequence, including at least one piece of structured or unstructured information, that is supplied as input to a generative AI model to cause the model to generate output text for controlling or assisting downstream processing.

The term “generative AI model” refers to a trained information processing model, such as a neural network model, configured to receive a prompt sentence as input and to generate text data, including at least one prompt sentence or message, according to learned patterns.

The term “update operation” refers to processing for obtaining new electronic certificate information and replacing or supplementing existing electronic certificate information used by an information processing apparatus.

The term “notification operation” refers to processing for generating, formatting, and transmitting notification information, including at least one message indicating a state of electronic certificate information, to a target such as a management terminal or user.

The term “electronic communication message” refers to electronic data formatted for transmission over a communication path, including at least one of an electronic mail message, a message in a messaging protocol, or a notification displayed via a network-based user interface.

The term “management terminal” refers to an information processing device operated by a management user or administrator, capable of receiving electronic communication messages and displaying management information relating to electronic certificate information.

The term “management screen” refers to a user interface presented on a display device of a management terminal or server, configured to visually present information related to monitoring, status, or control of electronic certificate information.

The term “display-control functionality” refers to processing capability that enables generation, update, and arrangement of visual elements on a management screen according to underlying status information and control commands.

The term “information processing apparatus” refers to a hardware and software combination, such as a server, client device, or embedded system, that executes one or more programs for processing data, including at least handling of electronic certificate information.

The term “electronic transaction process” refers to a sequence of computer-executed steps that implement a transaction involving electronic data, including at least one of authentication, authorization, data exchange, or settlement, and that depends on electronic certificate information for secure execution.

The term “procedure processing necessary for completing an electronic transaction process” refers to processing steps executed by an external program, including at least one of establishing or re-establishing secure sessions, updating credentials, or confirming transaction status, which are required to complete or resume an electronic transaction process.

The term “user-attribute information” refers to information associated with a user, including at least one of role, access rights, historical behavior, or profile data, used by a processor to assist in estimating a user emotional state or determining notification behavior.

The term “emotional-state estimation information” refers to input data used for estimating a user emotional state, including at least one of interaction logs, response patterns, biometric signals, or contextual signals obtained from the user or user environment.

The term “user emotional state” refers to an estimated cognitive or affective condition of a user, such as stress level, attention level, or fatigue state, inferred by a processor based on user-attribute information and emotional-state estimation information.

The term “notification timing” refers to a temporal condition, including at least a send time or frequency, at which a notification operation is performed to deliver notification information to a user or device.

The term “notification content” refers to information included in a notification message, including at least text, parameters, or metadata describing a state of electronic certificate information or an associated operation.

The term “notification priority” refers to an importance level or urgency level assigned to a notification, which influences at least one of ordering, emphasis, or handling of the notification within a computing environment.

The term “notification channel” refers to a communication medium or mechanism through which a notification is delivered, including at least one of electronic mail, a push notification, a dashboard alert, or a messaging protocol.

In one embodiment, a server implements a certificate management system that cooperates with one or more terminals and users to monitor electronic certificate information, generate control instructions using a generative AI model, and adaptively manage notifications and certificate updates.

The server includes one or more processors, a main memory, a non-volatile storage device, and a network interface. The server executes an operating system such as a general-purpose server operating system and application software including: a certificate-information acquisition program, a communication program, a database management program, a web application program for a management dashboard, and a generative AI client library. The server stores electronic certificate records, notification records, and user profile data in a structured data store such as a relational database.

The terminal includes a processor, a display device, an input device, and a network interface. The terminal executes a web browser or a dedicated management application that communicates with the server over a secure communication path such as a transport-layer security channel. The terminal displays a management screen generated by the server and accepts user input, such as acknowledgment of notifications or confirmation of certificate renewal status.

The user operates the terminal to view certificate-related notifications, to perform certificate renewal operations on one or more external systems, and to adjust configuration parameters such as thresholds or notification preferences. The user may be an administrator or an operator responsible for maintaining availability and security of information-providing services.

The server uses a certificate-information acquisition program to obtain electronic certificate information corresponding to a plurality of information-providing services. The server stores, for each service, a record including at least: a service identifier (for example, a domain name or endpoint identifier), a network address and port, a certificate source type, a last-checked timestamp, and one or more fields for validity-period information. The server invokes software having cryptographic processing functionality, such as a cryptographic library or command-line tool, via an inter-process communication mechanism. The server passes the network address and port to this software to initiate a handshake or to query certificate data. The cryptographic software returns certificate metadata in a structured or semi-structured format, including a “notBefore” time and a “notAfter” time.

The server parses the returned certificate metadata and stores validity-period information in a time-normalized format. The server represents each validity-period value as a timestamp in a unified time zone, for example, Coordinated Universal Time. The server maintains a data structure in memory where each element includes: a key field for a service identifier, a field for certificate expiration time, a field for certificate start time, and a field for a remaining validity value. The server computes the remaining validity value by subtracting the current system-time information from the expiration time using an arithmetic operation on the timestamp values. Because the server performs these computations using a unified internal representation, the server avoids locale-specific parsing errors and improves accuracy and determinism of expiration detection.

The server compares the remaining validity value to a predetermined threshold stored in configuration data. The server may store different thresholds per service or per service group. The server evaluates a comparison operation and assigns an approaching-expiration state when the remaining validity value is less than or equal to the threshold. This comparison is performed using integer or floating-point arithmetic on the normalized time values, which reduces rounding errors and enables consistent comparison across services.

The server generates a first prompt sentence when an approaching-expiration state is present. The server constructs the prompt sentence as a text sequence that includes structured tokens indicating: a service identifier, an expiration date expressed in a standardized text format, a remaining-days value encoded as a numeric string, and a category label indicating the type of operation (for example, “certificate_update” or “expiration_warning”). The server uses this prompt sentence as an input to a generative AI model.

The server implements the generative AI model as a neural network-based language model. In one example, the server uses a transformer-type neural network architecture comprising an input embedding layer, a plurality of self-attention layers, feed-forward layers, and a softmax output layer. The server stores model parameters in a parameter storage; each parameter is a real-valued weight or bias. The server may deploy this generative AI model locally or access a remote generative AI model via a network-based application programming interface. The server represents each token of the prompt sentence by an integer index into a vocabulary, then converts the indices to vectors via the embedding layer. The server applies multi-head attention operations and matrix multiplications across successive layers to compute output token probabilities. The server selects a sequence of output tokens according to a decoding strategy such as greedy decoding or sampling with temperature. As a result, the server obtains a second prompt sentence that contains instructions related to an update operation or notification operation for the corresponding certificate.

The server configures the generative AI model using training data that includes pairs of input prompt sentences and desired output instructions. During training, the server applies a loss function such as cross-entropy between predicted token probabilities and ground-truth tokens. The server updates the model weights using an optimization algorithm such as stochastic gradient descent or Adam. The server may perform fine-tuning using domain-specific data for certificate management notifications. Through this training and fine-tuning procedure, the server configures the generative AI model to generate prompt sentences that are structurally consistent, machine-interpretable, and contextually adapted to specific certificate states. The server processes the generated second prompt sentence with a rule-based interpreter. The server defines a set of rules mapping syntactic patterns or control tokens in the prompt to specific operations. For example, when the second prompt sentence contains a phrase such as “generate email notification with subject:” followed by content, the server parses the subject and body segments with a deterministic parser and binds them to fields in an internal notification object. When the second prompt sentence contains a directive such as “trigger auto-renewal workflow for service:” followed by a service identifier, the server invokes an update operation module that interacts with external software responsible for obtaining new certificate information. By combining the generative AI model with a rule-based interpreter, the server ensures that the output is not merely natural language, but carries explicit instructions that can be deterministically converted to control signals for existing software components.

The server uses a communication program with electronic communication-processing functionality to send messages to a management terminal. The server constructs an electronic communication message as a data object containing fields such as: sender address, recipient address, subject, body, creation time, notification priority, and channel type. The server chooses the channel type (email, dashboard alert, or other channel) according to rules derived from fields in the generated prompt sentence. The server serializes this data object into a protocol-compliant representation and transmits it via the network interface. The server logs the message and associated metadata into a notification record table, enabling subsequent queries and deduplication.

The server uses a web application program to render a management screen. The server retrieves certificate status records and notification records from the database and constructs a response that includes a representation of each service's certificate state, including approaching-expiration flags and timestamps. The server transmits this response as web content to the terminal, which then displays a management screen with rows or tiles indicating each service, its remaining validity period, and the existence of pending notifications. Because the server pre-computes and caches derived fields such as days-to-expiration and priority levels, the terminal can display a sorted and filtered view with minimal processing overhead, improving responsiveness and reducing communication latency.

The server controls execution of an acquisition process for new electronic certificate information based on the generated second prompt sentence. The server maps instructions in the prompt sentence to invocation parameters for an external certificate-management application or cryptographic library. For example, the server may invoke a renewal process with specified identifiers, challenge-response options, and key-length parameters. The server then receives new certificate data, validates it using cryptographic verification functions, and updates the certificate records in the database. The server writes new expiration timestamps, revocation status, and certificate-chain metadata, and atomically updates configuration files or key stores used by application servers. This coordination of prompt-driven renewal control improves the efficiency of certificate rotation and reduces the window of time during which outdated certificates remain installed.

The server also generates a third prompt sentence that includes information about the user emotional state and about the approaching-expiration state. The server estimates the user emotional state by processing user-attribute information and emotional-state estimation information. For instance, the server may derive features such as: frequency of prior alert acknowledgments, average response time, time-of-day usage patterns, and previous escalation actions. The server may further incorporate optional signals from the terminal, such as interaction speed or error rates, where such data is available and permitted. The server encodes these features as discrete tokens or as numeric values described in text (for example, “response_time_category: slow”). The third prompt sentence therefore includes both system-state context (for example, severity level of certificate expiration) and user-state context.

The server feeds the third prompt sentence into the generative AI model and obtains a fourth prompt sentence that contains instructions for adjusting notification timing and notification content. The fourth prompt sentence may, for example, indicate that high-severity notifications should use a high-priority channel and condensed wording when the user is inferred to be under high workload, whereas lower-severity notifications may be batched or postponed. The server parses the fourth prompt sentence and uses the contained instructions to modify scheduling parameters in its notification scheduler, such as next-send time, retry interval, and grouping behavior. The server also adjusts content templates selected for notifications, choosing shorter or more focused content formats when specified. The server uses a defined data structure for prompts and instructions, which reduces ambiguity and improves robustness. For example, the server can wrap each directive segment in a tagged format such as “ACTION:”, “SUBJECT:”, “BODY:”, or “SEVERITY:”. Even though the generative AI model outputs natural language, the presence of these tags allows the server to reliably parse and interpret the text. This hybrid approach of neural generation plus structured tagging differs from naive natural-language-only handling and yields technical benefits: the server can automatically adapt notification parameters without manual rewriting of templates or configuration, while maintaining consistent control logic and enabling static analysis of prompt outputs.

The server leverages pre-computed indexes and normalized data structures to reduce computation time when determining which services require notifications. The server maintains an index on expiration timestamps in the certificate records table, enabling efficient range queries for certificates expiring within a configurable time horizon. The server thereby reduces database query complexity and accelerates detection of approaching-expiration states across large service fleets. Combined with the generative AI-based content adaptation, this design decreases latency between detection and notification, and allows the system to scale to many more monitored services than traditional static-script approaches.

The server improves computational efficiency and reduces communication load by aggregating related notifications. When the fourth prompt sentence indicates that multiple services can be combined into a summary message, the server constructs a single message that lists all relevant services, rather than sending separate messages. The server uses an internal aggregation mechanism that groups entries by user, severity, and time window. This grouping reduces the number of transmitted messages, decreases network traffic, and lessens the burden on mail servers and terminals, while still ensuring that critical information is prominently presented.

The server realizes a technical improvement over simple human task automation because the generative AI model is not merely replicating human drafting behavior. Instead, the server uses the model output as a dynamic control layer for the certificate management pipeline. The server uses model-generated instructions to drive concrete actions: scheduling network calls for certificate retrieval, controlling which external programs to execute, adjusting database access patterns, and modifying how and when messages are transmitted over the network. The server thus modifies the behavior of the computing system at runtime in ways that human operators could not feasibly manage manually at large scale or fine granularity. The server also achieves increased accuracy in certificate expiry detection and reduced false alert rates. By normalizing time data and by systematically incorporating thresholds, severity levels, and user-response feedback into subsequent generative prompt sentences, the server converges toward optimal alerting strategies. In particular, the server can use historical notification outcomes (for example, whether a user acknowledged a notice before expiration) as training or fine-tuning data for the generative AI model. This feedback loop leads to adaptation of notification phrasing and timing that more reliably elicits timely responses, thereby decreasing the chance that certificates will remain unrenewed until after expiration. In one specific example, the server generates the following prompt sentence to obtain a template for an email notification:

“Create a polite, concise English notification e-mail for a system administrator. The e-mail should warn that an SSL/TLS certificate for {domain} will expire on {expire_date}, with {days_left} days remaining. Include a short subject line and a clear call to action to renew the certificate.”

In another example, the server generates a prompt sentence to adjust dashboard notifications: “Generate a concise dashboard notification message for an administrator when a certificate is within {days_left} days of expiration. The message should include {domain} and {expire_date}, and it should be suitable for display in a web UI alert panel.” The server uses these prompt sentences not only to obtain user-facing text, but also to structure downstream control data. For example, the model output can contain lines such as “PRIORITY: high” or “CHANNEL: email_and_dashboard,” which the server parses and maps to numeric priority codes and channel flags in its notification scheduler structures. The terminal receives notification messages and dashboard content from the server. The terminal displays the management screen, including certificate status indicators and notification banners. The terminal sends user commands back to the server, such as acknowledgment of a notification or marking a certificate as renewed. Based on these inputs, the server updates its records, which may include clearing or lowering alert levels, resetting notification counters, and adjusting future alerting behavior. This bidirectional interaction contributes to accurate modeling of user behavior and enables the server to refine its generative prompt strategies.

The user interacts with the terminal to inspect certificate data, verify the correctness of certificate installations, and initiate external renewal processes where required. The user can configure preferences for notification channels, language, and severity thresholds. The server takes these preferences into account when generating prompt sentences and interpreting model output, leading to a tailored certificate management experience and improved usability.

In alternative embodiments, the server may employ different generative AI model architectures, such as recurrent neural network-based language models or hybrid models combining symbolic and neural components. The server may run the generative AI model fully on-premises, within a virtualized environment, or may delegate inference to an external inference service via secure application interfaces. The server may also apply alternative feature sets for emotional-state estimation, such as workload metrics from a ticketing system, while still maintaining the described data structures and control flow.

In further embodiments, the server may integrate certificate status information from multiple certificate authorities and may coordinate different renewal strategies according to policies encoded in the prompt sentences. The server may also support diverse communication pathways, such as short text messages or application-level push notifications, controlled through the same generative prompt mechanism and interpreted commands. These variations share the core technical approach of using structured prompt sentences and a generative AI model to produce machine-actionable control instructions that improve the performance, accuracy, and scalability of computer-based certificate lifecycle management.

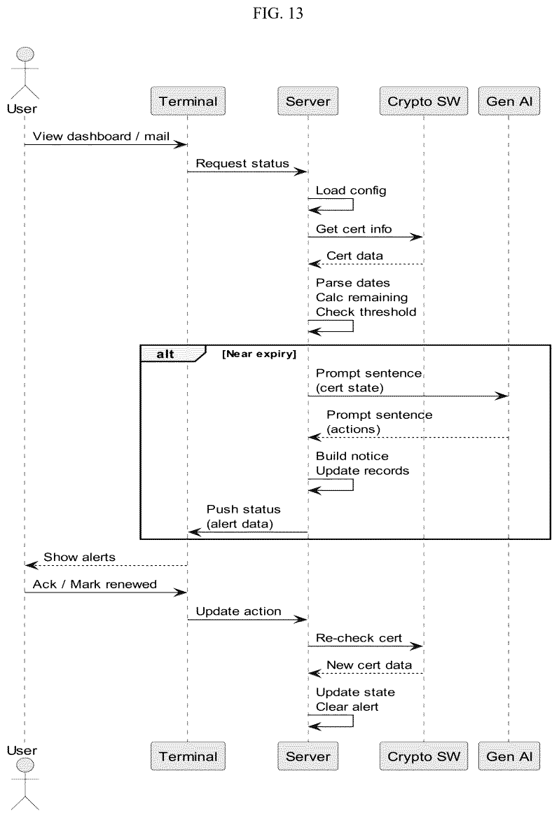

The following describes the processing flow using FIG. 13.

### Step 1:

Server loads configuration data and initializes internal structures.

Server reads, as input, configuration information stored in a storage device, including a list of service identifiers, corresponding network endpoints, threshold values for remaining validity periods, notification channel preferences, and parameters for the generative AI model. Server parses this configuration file or database table and constructs, as output, in-memory data structures such as arrays or dictionaries mapping each service identifier to its endpoint, threshold, and policy settings. Server thereby prepares structured data that will be referenced in subsequent processing steps.

### Step 2:

Server acquires raw certificate data for each monitored service.

Server uses, as input, the service identifiers and network endpoints prepared in Step 1. For each service, server invokes software having cryptographic processing functionality, such as a command-line tool or cryptographic library, by passing the target host name and port through an inter-process communication call. The cryptographic software performs a network handshake and returns, as output, raw certificate metadata including at least a “notBefore” field, a “notAfter” field, and issuer and subject information. Server collects this output as a text or binary buffer and associates it with the corresponding service identifier in memory.

### Step 3:

Server parses validity-period information and normalizes time values.

Server uses, as input, the raw certificate metadata buffers generated in Step 2. Server applies parsing logic, for example by scanning for date labels and using date-format parsing functions, to extract expiration timestamps from the metadata. Server converts each extracted timestamp into a normalized internal representation, such as a 64-bit integer indicating seconds since a reference epoch in a unified time zone. As output, server stores, for each service identifier, a normalized expiration time and, optionally, a normalized start time in a structured record in memory or in a database. This data conversion from unstructured text to structured timestamps enables consistent arithmetic processing in later steps.

### Step 4:

Server computes remaining validity periods and identifies approaching-expiration states. Server uses, as input, the normalized expiration times stored in Step 3 and current system-time information obtained from a system clock. Server subtracts the current time from each expiration time using arithmetic operations to compute a remaining validity interval, typically in seconds or days. Server then compares this computed interval against the corresponding threshold value for each service obtained from the configuration in Step 1. As output, server generates, for each service, a remaining validity value and a Boolean or categorical flag indicating whether the service is in an approaching-expiration state. Server writes these values into its internal status records and may persist them to a database.

### Step 5:

Server selects target services for notification and update control.

Server uses, as input, the approaching-expiration flags and remaining validity values from Step 4, along with recent notification history and policy settings. Server evaluates selection criteria, for example “flag is true” and “no notification sent within the last configured time window,” by comparing timestamps and flags in the notification records. Based on these computations, server produces, as output, a subset list of service identifiers that require generation of control instructions for notification and possibly for certificate update. Server stores this subset list in memory for use in prompt generation.

### Step 6:

Server constructs first prompt sentences containing certificate state information. Server uses, as input, the subset list of services from Step 5 and, for each service, its identifier, expiration date, remaining validity value, and severity level derived from thresholds. Server formats these values into one or more text strings that follow a defined prompt template, for example including labeled fields such as “SERVICE:”, “EXPIRE_DATE:”, and “DAYS_LEFT:”. Server may also append policy indicators, such as desired language or tone, as additional textual markers. As output, server generates one or more first prompt sentences, each encoding the state of at least one electronic certificate, and stores them as strings ready to be delivered to a generative AI model.

### Step 7:

Server generates second prompt sentences using the generative AI model.

Server uses, as input, the first prompt sentences produced in Step 6. Server tokenizes each prompt sentence into discrete tokens, maps tokens to numeric indices using a vocabulary table, and supplies the token sequence to a generative AI model implemented as a neural network. Inside the model, matrix multiplications, attention operations, and non-linear activation functions are applied to compute probability distributions over possible output tokens. Server decodes these distributions using a decoding algorithm, such as greedy decoding or sampling, to obtain, as output, second prompt sentences that describe instructions for at least one update operation and/or notification operation. Server collects these second prompt sentences as text strings and associates each with its corresponding service identifier.

### Step 8:

Server interprets second prompt sentences to generate structured control instructions. Server uses, as input, the second prompt sentences obtained in Step 7. Server applies rule-based parsing logic to locate control tags, keywords, and delimiters within each sentence, for example “ACTION: send_email”, “PRIORITY: high”, or “AUTO_RENEW: enabled”. Server then maps these textual elements to structured control objects with fields such as action type, target channel, subject text, body text, and renewal flag. As output, server produces a set of internal instruction objects that can be directly used to drive email generation, dashboard updates, and certificate update workflows. Server stores these objects in memory for subsequent execution.

### Step 9:

Server composes and transmits electronic communication messages to terminals.

Server uses, as input, the structured control objects generated in Step 8 and administrator contact information obtained from configuration data or user records. Server assembles email messages or other communication payloads by inserting subject text, body content, and header information into a message object. Server may also convert abstract priority levels into protocol-specific flags or markers. Server uses a communication library to open network connections to messaging servers, performs protocol-specific handshakes, and transmits the serialized message objects as packets over the communication path. As output, server obtains transmission results, such as success or error codes, and records these results, along with timestamps, into notification history records.

### Step 10:

Server updates dashboard data and provides certificate status information to terminals. Server uses, as input, the latest certificate state data from Step 4, the instruction objects from Step 8, and the notification history from Step 9. Server writes or updates entries in a dashboard-status table, including fields for service identifier, expiration time, remaining validity, state flag, and last-notification information. Server processes client requests from terminals for dashboard views by querying this table, sorting and filtering results based on severity or remaining days, and packaging the data into a response format such as structured text or markup. As output, server sends this response to the requesting terminal, which can render the management screen with updated status indicators.

### Step 11:

Terminal displays notification information and accepts user input.

Terminal uses, as input, electronic communication messages received from the server and dashboard status data delivered in Step 10. Terminal parses message headers and bodies to display notification content in an email client or notification panel. Terminal also loads the dashboard response into a web browser or management application and renders visual components such as tables, color indicators, and action buttons corresponding to each service. As output, terminal produces user interface events when the user interacts with displayed elements, such as clicking an “Acknowledge” button or selecting a “Mark as Renewed” option, and transmits corresponding user commands back to the server over the network.

### Step 12:

User inspects notifications and performs certificate-related actions.

User uses, as input, the notification content and dashboard information presented on the terminal display. User reads expiration dates, remaining days, and severity indicators, and decides which services require immediate attention. User then initiates certificate renewal using appropriate tools or external systems, and optionally returns to the management screen to record completion of renewal by selecting a corresponding control. As output, user generates confirmation input, such as acknowledgment or completion signals, which are captured and transmitted by the terminal to the server.

### Step 13:

Server updates internal records based on user actions and verifies new certificate states. Server uses, as input, user commands received from the terminal in Step 12, including identifiers of services marked as acknowledged or renewed. Server updates its notification history and dashboard-status records to reflect these user actions, for example by setting acknowledgment flags and updating timestamps. Server may then trigger a targeted certificate check for the affected services by re-executing Steps 2 through 4 for those services alone. As output, server obtains new validity-period information, recomputes remaining validity, and, if new certificates have been correctly installed, clears or downgrades approaching-expiration flags, thereby closing the loop between detection, notification, user response, and system state verification.

### Step 14:

Server generates user-context-aware prompt sentences for adaptive notification control. Server uses, as input, historical interaction data, such as user acknowledgment times, missed alerts, and response patterns, as well as current certificate states and any available emotional-state estimation signals. Server aggregates these values into features, for example categorical response-speed labels or usage-time windows, and represents them in text form. Server combines these features with current approaching-expiration indicators into a third prompt sentence that encodes both user context and system context. As output, server passes this third prompt sentence to the generative AI model, which produces a fourth prompt sentence containing refined instructions for notification timing, grouping, and content tailoring. Server interprets the fourth prompt sentence using its rule-based parser and updates scheduling parameters and template selections accordingly, enabling subsequent executions of Steps 6 through 10 to produce more effective and technically optimized notifications.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional certificate management systems typically separate low-level technical operations (such as certificate expiry monitoring, renewal, and deployment) from high-level user communication (such as notifications to administrators). In many implementations, notification logic is implemented as static templates and fixed schedules, irrespective of the administrator's current workload or emotional state, and irrespective of service risk levels. As a result, these systems can generate either excessive alerts that contribute to alert fatigue and delayed responses, or insufficiently timely alerts that fail to prevent service outages caused by expired digital certificates.

Furthermore, known systems generally do not exploit generative artificial intelligence to dynamically tailor notification content and timing based on real-time system state and user context. Existing approaches treat generative artificial intelligence, if used at all, as a separate, manual tool rather than an integrated component of automated certificate lifecycle management. As a consequence, the computing resources responsible for certificate monitoring, renewal, deployment, and notification scheduling are not coordinated in an adaptive, feedback-driven manner, and do not benefit from automated optimization of notification behavior.

In addition, there is no unified control mechanism that uses prompt sentences as a machine-readable interface between system-level state (such as certificate status, service risk, and user emotion) and a generative AI model, in order to generate technically accurate yet context-sensitive notification messages. Without such a mechanism, the processor cannot effectively leverage generative AI outputs in a closed feedback loop: notification performance (for example, timing and clarity) cannot be systematically improved using user feedback, and notification priority across multiple media (for example, push, email, dashboard) cannot be automatically calibrated according to both service criticality and user emotion. Accordingly, there is a need for an improved computer-implemented system in which a processor coordinates (i) fine-grained monitoring and control of digital certificate state and deployment, (ii) analysis of user emotion derived from terminal interaction data, and (iii) generation, scheduling, and adaptation of notification messages via prompt sentences to a generative AI model, such that notification timing, channel selection, and content are automatically optimized. Such a system should enhance the reliability and availability of network services by reducing certificate-related outages, while simultaneously improving the efficiency and effectiveness of administrative interaction with the system.

The specific processing by the specific processing unit 290 of the data processing device 12 in Application Example 2 is realized by the following means.

The present invention provides a server comprising a processor configured to acquire attribute information of a digital certificate, calculate a remaining validity period on the basis of validity period information included in the attribute information and current time information, compare the remaining validity period with a plurality of predetermined threshold values, determine a certificate state in accordance with a result of the comparison, and generate state information indicating the certificate state; to generate control information for causing a certification infrastructure to execute an issuance request for a new digital certificate and a fee settlement process when the certificate state satisfies an update condition, to transmit and receive information with an external certificate issuing apparatus and an external settlement apparatus via a communication processing apparatus on the basis of the control information, to acquire a new digital certificate and settlement result information, and to reflect the acquired new digital certificate in setting information of an information processing apparatus for providing a network service; to acquire emotion information indicating an estimated emotional state of a user on the basis of behavior information or input information acquired from a user terminal, and to determine notification condition information indicating an execution timing of a notification and an importance degree of the notification on the basis of the emotion information and the certificate state; to generate a prompt sentence including situation information comprising a type of a notification target medium and a technical event to be notified and expression condition information comprising a writing style and a length required for the notification, on the basis of the certificate state, the emotion information, and the notification condition information, to input the prompt sentence to a generative AI model, to acquire response information including a notification text candidate corresponding to the situation information and the expression condition information, and to select or generate a notification message from the notification text candidate on the basis of the notification condition information; to transmit the notification message to the user terminal via a message distribution infrastructure at a transmission time determined on the basis of the notification condition information, and to instruct the user terminal to update at least one of a display of a state of the digital certificate and an operation screen; and to generate adaptation control information by generating an additional prompt sentence for input to the generative AI model, the additional prompt sentence including response information and feedback information acquired from the user terminal for the notification, and updating at least one of the notification condition information and a generation condition of the prompt sentence on the basis of the response information and the feedback information. This enables the server to implement an integrated, computer-implemented control loop in which certificate lifecycle operations, emotion-aware notification scheduling, and generative-AI-based message generation are coordinated in real time, thereby improving robustness of service availability, reducing unnecessary or ill-timed alerts, and dynamically optimizing notification behavior based on system state and user feedback.

The term “digital certificate” refers to electronic authentication information used in a communication system to verify an entity and to protect exchanged data, the electronic authentication information including at least identification information and validity period information.

The term “attribute information of a digital certificate” refers to information associated with a digital certificate, the information including at least a subject identifier, an issuer identifier, a validity period, and one or more parameters for use in a cryptographic operation.

The term “remaining validity period” refers to a time difference calculated between a current time and an expiration time included in validity period information of a digital certificate.

The term “certificate state” refers to a classification result indicating a condition of a digital certificate, the classification result being determined on the basis of at least the remaining validity period and one or more threshold values, and including, for example, a normal state, a near-expiry state, or an expiry state.

The term “state information” refers to data indicating a certificate state in a machine-readable format, the data being used by a processor to control a renewal operation, a deployment operation, and a notification operation.

The term “threshold value” refers to a time value or other reference value used as a criterion to compare with a remaining validity period or another metric in order to determine a certificate state.

The term “update condition” refers to a condition that triggers issuance or renewal of a digital certificate, the condition being defined on the basis of at least one of a remaining validity period, a certificate state, a configuration parameter, and a service policy.

The term “certification infrastructure” refers to a system including at least one external device configured to issue a digital certificate, to validate a digital certificate, or to manage a lifecycle of a digital certificate.

The term “issuance request” refers to a request message transmitted from a server to a certification infrastructure to obtain a new digital certificate or to renew an existing digital certificate.

The term “fee settlement process” refers to a transaction process in which a payment apparatus processes payment information for a fee associated with issuance or renewal of a digital certificate.

The term “external certificate issuing apparatus” refers to an external processing apparatus configured to generate and provide a digital certificate in response to an issuance request.

The term “external settlement apparatus” refers to an external processing apparatus configured to process payment information and to return settlement result information for a fee associated with issuance or renewal of a digital certificate.

The term “communication processing apparatus” refers to a processing apparatus or a functional unit configured to transmit and receive information between a server and at least one external apparatus via a communication network.

The term “information processing apparatus for providing a network service” refers to an apparatus including at least a processor and a communication interface, the apparatus being configured to provide a service via a communication network using at least one digital certificate.

The term “setting information” refers to information used to configure operation of an information processing apparatus, the information including at least a file path or an identifier of a digital certificate used by the information processing apparatus.

The term “user terminal” refers to an information processing apparatus operated by a user, the apparatus being configured to exchange information with a server and to present notification information or status information to the user.

The term “behavior information” refers to information representing an operation history or an interaction pattern of a user with respect to a user terminal or a service, the information including at least one of operation logs, access logs, input sequences, and usage times.

The term “input information” refers to information explicitly input by a user via a user interface of a user terminal, the information including at least one of text data, selection data, and control commands.

The term “emotion information” refers to data indicating an estimated emotional state of a user, the data being derived from behavior information or input information by an emotion analysis process.

The term “notification condition information” refers to control information indicating at least an execution timing of a notification and an importance degree or priority of the notification, the control information being determined on the basis of a certificate state and emotion information.

The term “notification target medium” refers to a communication channel or an output medium used to deliver a notification to a user, the communication channel or output medium including at least one of a push notification channel, an electronic mail channel, and a screen display channel.

The term “technical event to be notified” refers to an event related to a state or a lifecycle of a digital certificate or a network service, the event including at least one of an approaching expiration, a completion of renewal, a failure of deployment, and a change of risk level.

The term “writing style” refers to a linguistic characteristic of a notification message, the characteristic including at least one of formality, tone, and politeness level.

The term “expression condition information” refers to control information indicating at least a writing style and a length of a notification message to be generated.

The term “prompt sentence” refers to machine-readable text provided as an input to a generative AI model, the machine-readable text describing at least situation information and expression condition information used to generate a notification text candidate.

The term “generative AI model” refers to a machine learning model configured to generate natural language text in response to an input prompt sentence, the model being trained on language data and being executable on a computing apparatus.

The term “situation information” refers to information included in a prompt sentence, the information describing at least a type of a notification target medium and a technical event to be notified.

The term “notification text candidate” refers to a generated text output by a generative AI model in response to a prompt sentence, the generated text being a candidate for use as a notification message.

The term “notification message” refers to a message determined by a processor for transmission to a user terminal, the message being selected or generated from at least one notification text candidate on the basis of notification condition information.

The term “message distribution infrastructure” refers to a system configured to relay or distribute messages from a server to one or more user terminals via at least one communication network.

The term “operation screen” refers to a graphical user interface presented on a user terminal, the graphical user interface enabling a user to view information and to perform an operation related to a digital certificate or a network service.

The term “response information” refers to information indicating a reaction of a user or a user terminal to a notification message, the information including at least acknowledgement data, action data, or access data.

The term “feedback information” refers to information explicitly or implicitly provided by a user regarding evaluation of a notification, the information including at least one of preference data, evaluation scores, and free-text comments.

The term “additional prompt sentence” refers to a prompt sentence generated for input to a generative AI model, the prompt sentence including at least response information and feedback information for use in adjusting notification behavior.

The term “adaptation control information” refers to control information for updating at least one of notification condition information and a generation condition of a prompt sentence on the basis of response information and feedback information.

The term “notification priority control information” refers to information indicating a relative priority of notifications across a plurality of notification media, the information being generated on the basis of a certificate state and emotion information.

In the following embodiments, a “server” denotes an information processing apparatus including at least one processor, a main memory, a non-volatile storage device, and a network interface. A “terminal” denotes an information processing apparatus operated by a user and capable of communicating with the server via a communication network. A “user” denotes an operator, such as a system administrator, who interacts with the terminal. Server executes a program stored in the non-volatile storage device and loaded into the main memory. The program is implemented, for example, as an application running on an operating system such as a general-purpose server operating system, and uses middleware components including a relational database management system, a web server, and external libraries such as a cryptographic library and a communication library. The program may be implemented as a set of modules written in a high-level language, and each module corresponds to a functional unit described below.

Server uses a cryptographic library, such as an SSL/TLS library, to acquire attribute information of a digital certificate. Server stores, in a relational database, certificate records including fields such as a certificate identifier, a domain identifier, a file path to a certificate file, a file path to a private key file, an issuer identifier, a validity period start time, a validity period end time, and a current certificate state. Server stores the records as rows in a table, and indexes the rows on at least the domain identifier and the validity period end time to enable efficient access.

Server uses an internal time source of the operating system to obtain current time information. Server represents both the current time and the validity period end time in a unified time format, such as an epoch time or a standard time object, and computes a remaining validity period by subtracting the current time from the validity period end time. Server writes the remaining validity period into a field of the certificate record, and compares the remaining validity period with a plurality of threshold values stored in a configuration table in the database. The threshold values may include, for example, a first threshold for starting an automatic renewal and a second threshold for starting an urgent notification. Server determines a certificate state by applying a rule set to the remaining validity period and additional parameters such as previous renewal failures and service criticality. For example, Server classifies a certificate into a normal state when the remaining validity period is greater than the first threshold, into a near-expiry state when the remaining validity period is less than or equal to the first threshold and greater than the second threshold, and into a high-risk state when the remaining validity period is less than or equal to the second threshold or when a previous renewal has failed. Server converts the classification result into state information represented as a code, such as an integer or an enumeration, and stores the state information in the certificate record.

Server uses a communication processing module to interact with an external certification infrastructure and an external settlement apparatus. Server generates control information for issuing a new digital certificate by constructing a structured request message that includes at least a domain identifier, a key usage type, a public key, and desired validity parameters. Server transmits the request message over a secure communication channel to the certification infrastructure. When a fee is required, Server also generates payment information, including at least a fee amount and a payment method token, and transmits the payment information to a settlement apparatus. Server receives issuance result information containing the new digital certificate and settlement result information indicating a success or failure of payment, and stores these results in the database.

Server reflects the new digital certificate in setting information of a service-providing information processing apparatus such as a web server. Server writes the certificate file and the private key file to predetermined directories in a file system, and updates configuration entries of the service-providing information processing apparatus. For example, Server updates fields in a configuration table, or rewrites lines in a configuration file to reference the new certificate file path and private key file path. Server then instructs the information processing apparatus to reload or restart a network service process, thereby binding the new digital certificate to actual communication sessions with client devices.

Terminal acquires behavior information and input information from the user. Terminal monitors, for example, key input activity, navigation events within an administrative application, access frequencies to specific status pages, and explicit text input in feedback forms. Terminal transforms these events into structured behavior information by assigning timestamps, identifiers of UI components, and event types to each event, and transmits the structured data to Server via an application programming interface.

Server receives the behavior information and input information from Terminal and executes an emotion analysis process. In one embodiment, Server uses a neural network model trained to estimate emotion information from textual and behavioral features. The neural network may be implemented as a transformer-based architecture with multiple self-attention layers, feed-forward layers, and layer normalization components. The model input may include tokenized text representing user messages, combined with numerical features representing user interaction patterns such as inter-event intervals, time-of-day distributions, and frequency of error operations. Server normalizes the numerical features, embeds the categorical features, and concatenates the resulting vectors with text embeddings before feeding them into the neural network.

Server uses a supervised learning procedure to train the neural network. During training, Server uses a labeled dataset in which each sample includes user text, behavior features, and a ground-truth emotion label such as stress level or valence/arousal values. Server defines an error function such as a cross-entropy loss over emotion classes or a mean squared error over continuous emotion scores. Server applies a gradient-based optimization method, such as a variant of stochastic gradient descent with adaptive learning rates, to update model parameters. Server may use regularization techniques such as dropout, weight decay, and data augmentation (for example, paraphrasing or time-shift augmentation of behavior sequences) to improve generalization.

Server deploys the trained model and executes inference by passing current user data through the model to obtain emotion information. Server maps the model output to discrete states such as “high stress,” “low stress,” “relaxed,” or “focused,” and stores emotion information along with timestamps in an emotion state table. Server further aggregates historical emotion information to estimate patterns such as typical low-stress intervals for the user. Server determines notification condition information by combining the certificate state and the emotion information. Server evaluates, for example, whether a certificate is in a high-risk state and whether the user is in a high-stress state. When Server detects that a certificate is in a high-risk state and that the user is currently in a high-stress state, Server sets, in the notification condition information, a delayed execution timing that corresponds to a predicted low-stress interval derived from the historical emotion state table. When Server detects that a certificate is in a high-risk state and that the user is in a low-stress or focused state, Server sets an immediate or near-term execution timing, and assigns a high importance degree to the notification.

Server uses a specific data structure to store the notification condition information, for example, a record containing a certificate identifier, a user identifier, a scheduled send time, an importance level, and one or more preferred notification media identifiers. This structure allows Server to compute scheduling decisions and to adjust priorities across multiple notifications using a deterministic algorithm without scanning unstructured logs. As a result, Server reduces computation time for scheduling updates and improves scalability when managing a large number of certificates and users.

Server constructs a prompt sentence as a machine-readable representation that binds internal system state and desired notification properties to the input space of a generative AI model. Server generates, for each notification candidate, a prompt sentence that includes at least situation information and expression condition information. Situation information may comprise a description of the certificate state, the service risk, and the notification target medium. Expression condition information may comprise a desired writing style, such as calm or friendly, and a target length such as a short push notification or a more detailed email.

For example, Server may construct the following prompt sentence:

“Generate a short, calm email that informs the administrator that the digital certificate for example.com will expire in 7 days, has already been renewed successfully, and does not require immediate action. Use a neutral and non-alarming tone.”

In another example, Server may construct:

“Generate a friendly push notification for a relaxed administrator, telling them that the digital certificate for example.com has been auto-renewed and will expire on 2023 Dec. 1, and that no further action is required.”

Server calls a generative AI model by transmitting the prompt sentence, together with model parameters such as a temperature parameter and a maximum token length, to a model-execution service. The generative AI model may be implemented as a transformer-based language model with a large number of parameters and trained on a corpus including general and technical text. Server uses a deterministic or constrained decoding algorithm, such as beam search with a penalty for repetition, so that the generated output remains consistent with the situation information.

Server receives a notification text candidate from the generative AI model and performs post-processing. Server verifies that the notification text candidate contains essential technical elements, including at least a domain identifier and an expiry date or renewal status. If the candidate is missing required information, Server may generate an additional prompt sentence that explicitly requests inclusion of missing fields, and may repeat the generation. Server maps the candidate text to the internal notification message structure, adding references to links or action buttons that the terminal can display.

Server stores the notification messages along with the notification condition information in a notification queue. Server then uses the scheduled send times to control interaction with a message distribution infrastructure. For example, Server uses a push messaging gateway to deliver notification messages to mobile terminals, and an email transfer agent to deliver email notifications to inboxes. Server provides, in the notification payload, identifiers that allow Terminal to associate each notification with a certificate record and to update the display accordingly.

Terminal receives a notification message via the message distribution infrastructure. Terminal displays the message using a native user interface framework, such as a notification banner or an in-application dialog. Terminal also requests additional details from Server by invoking an application programming interface to retrieve the current certificate state, including key fields such as the expiry date, last renewal time, and the presence of any errors. Terminal renders this information on an operation screen that uses icons or other graphical indicators to show risk level and status, thereby giving the user real-time feedback on the certificate lifecycle.

User views the operation screen on Terminal and may provide explicit feedback on notification timing or clarity. For example, User may input text such as “Notification timing was bad; please send earlier in the day” or may select a preference option that indicates dissatisfaction with late-night notifications. Terminal transmits this feedback information, along with response information such as the time taken to open the notification and the navigation path followed by the user, to Server.

Server generates an additional prompt sentence that incorporates the response information and the feedback information. For example, Server may construct:

“Analyze this feedback: ‘Notification timing was bad; please send earlier in the day.’ Suggest how to adjust future digital certificate renewal notification timing for this administrator.” Server inputs this additional prompt sentence to the generative AI model and receives a text response that may propose modified scheduling rules, such as restricting notifications to office hours or preferring specific time windows. Server parses the response, extracts proposed changes, and converts them into adaptation control information that updates internal scheduling parameters, such as the allowed notification time range and the weighting for particular emotion states.

By using prompt sentences as an interface, Server can combine deterministic rule-based logic with the generative capabilities of the AI model while keeping control of technical constraints such as inclusion of required fields, enforcement of timing policies, and mapping to structured scheduling data. This design improves the internal architecture of the notification subsystem: Server maintains a clear separation between state computation, prompt generation, model execution, and post-processing, which allows more efficient caching, logging, and failure recovery than a monolithic implementation.

The described configuration improves computer technology in several respects. First, Server reduces processing load and improves latency for large-scale certificate monitoring by computing certificate states using indexed database operations and compact state codes, allowing efficient batch evaluation of thresholds and incremental updates. Second, Server improves notification accuracy and relevance by combining quantitative emotion information and certificate states in an algorithmic decision process for notification condition information, which reduces unnecessary alerts and increases the probability that a critical alert is read and acted upon promptly. Third, Server improves data management by using explicit data structures for certificate records, emotion states, and notification queue entries, which supports efficient queries and updates, log-based recovery, and auditing.

In addition, the use of a neural network-based emotion analysis and a generative AI model enables non-trivial optimization beyond human manual rule design. The neural network internal processing uses gradients and error functions that cannot be replicated efficiently by a human and relies on high-dimensional parameter space exploration to learn patterns in user behavior and language. The generative AI model processes prompt sentences according to learned probability distributions and generates diverse text candidates under constraints specified by expression condition information, which differs fundamentally from static human-written templates. The combination of these models with deterministic scheduling logic creates a feedback loop that systematically adapts notification behavior based on measurable outcomes, thereby enhancing the overall performance of the computer system. Alternative embodiments are possible. In one embodiment, Server uses a different generative AI architecture, such as a recurrent neural network or a hybrid model combining convolutional and attention layers, but still receives prompt sentences and returns notification text candidates. In another embodiment, Terminal performs a portion of the emotion analysis locally using a lightweight model, and transmits only aggregated emotion information to Server, thereby reducing network traffic and preserving privacy. In yet another embodiment, Server applies additional optimization methods, such as clustering of users with similar emotion patterns and certificate responsibilities, to compute group-level scheduling policies that reduce communication bursts on the message distribution infrastructure.

In all embodiments, Server, Terminal, and User interact through specifically defined data structures and processes that coordinate certificate lifecycle management with emotion-aware, generative-AI-assisted notification. The system thus achieves technical effects including improved robustness of network services through reduced certificate expiry incidents, enhanced computational efficiency in scheduling and generating notifications, and reduced communication overhead by adapting message content and timing to the context of both system state and user emotion.

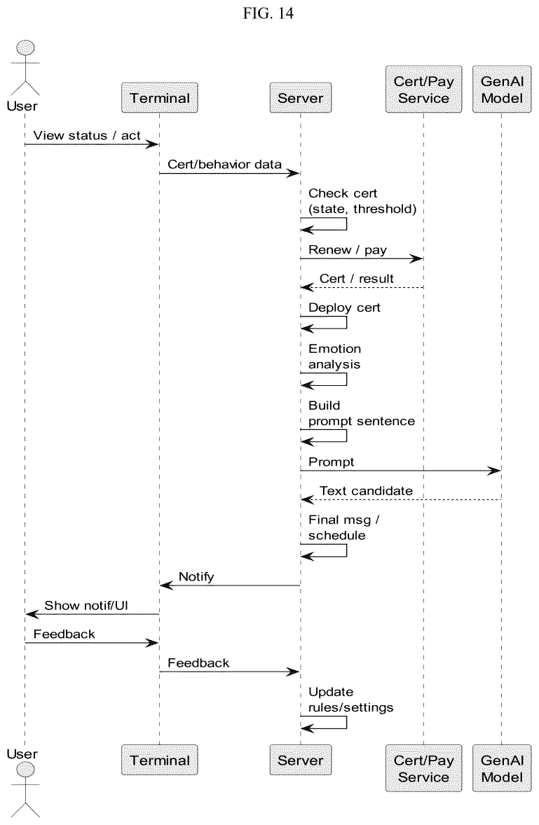

The following describes the processing flow using FIG. 14.

### Step 1:

Server retrieves certificate records and current time.

Server uses a database interface to read certificate records from a certificate table. The input is a query condition (for example, all active certificates), and the output is a list of certificate records including at least a certificate identifier, a domain identifier, and a validity period end time. Server also acquires current time information from an operating system clock. Server converts the validity period end time and the current time into a unified time format and prepares them as numeric values for later calculation.

### Step 2:

Server computes remaining validity periods and determines certificate states.

Server uses the validity period end time and the current time as input to compute a remaining validity period for each certificate by subtracting the current time from the end time. Server then reads threshold values (for example, a renewal threshold and an urgent threshold) from a configuration table. Server performs a comparison operation between each remaining validity period and the thresholds. The output is a certificate state code for each certificate, such as “normal,” “near-expiry,” or “high-risk.” Server writes the remaining validity period and the certificate state code back into the corresponding certificate records in the database.

### Step 3:

Server selects certificates that satisfy update conditions.

Server uses certificate state codes and configuration parameters as input to identify certificates that require renewal. Server evaluates an update condition such as “state is near-expiry or high-risk” and “auto-renew flag is enabled.” The data processing is a filtering operation on the list of certificate records. The output is a subset of certificate identifiers that must be renewed. Server stores this subset in a temporary structure or a job queue for further processing

### Step 4:

Server generates control information for certificate issuance and payment.

Server uses the subset of certificate identifiers as input and fetches detailed information, including domain identifiers, key parameters, and fee settings, from the database. Server constructs control information objects that include a certificate issuance request payload and, when required, a payment request payload. The data processing includes assembling JSON or similar structured messages that specify domain names, key types, and payment amounts. The output is a set of issuance control messages and payment control messages ready to be sent to external systems.

### Step 5:

Server communicates with certification infrastructure and settlement apparatus. Server uses the issuance and payment control messages as input to perform secure network communication. Server sends an issuance request to a certification infrastructure via a communication processing module and receives a response containing new digital certificate data. Server also sends a payment request to a settlement apparatus and receives settlement result information. The data processing includes encryption, transmission, reception, and parsing of protocol messages. The output is a mapping between each certificate identifier and the acquired new certificate data and settlement result data, which Server stores in the database.

### Step 6:

Server deploys new certificates to service-providing information processing apparatuses. Server uses the new certificate data and configuration information for each service as input. Server writes the certificate file and private key file to designated directories in a file system and updates configuration settings of a network service process, such as a web server. The data processing includes path resolution, file write operations, and configuration file modification. The output is an updated configuration state and a deployment status code indicating whether the network service process successfully reloaded the new certificate. Server records the deployment status in a deployment log table.

### Step 7:

Terminal collects user behavior and input information.

Terminal uses user interactions with an administrative application as input. Terminal monitors events such as screen transitions, button clicks, typing activities, and feedback form submissions. Terminal transforms each event into structured behavior information by attaching timestamps, event types, and component identifiers. The data processing includes event capturing and serialization to a structured format. The output is a behavior information dataset, which Terminal transmits to Server via an application programming interface.

### Step 8:

Server derives emotion information from behavior and input information.

Server uses the behavior information and any user-provided text as input to an emotion analysis module. Server extracts features such as event frequency, inter-event time intervals, time-of-day patterns, and linguistic features from text. Server feeds these features into a trained neural network model to compute emotion scores. The data processing includes feature normalization, embedding, and forward propagation through the model. The output is emotion information indicating an estimated emotional state (for example, “high stress,” “low stress,” or “relaxed”) with associated confidence values. Server writes this emotion information to an emotion state table with timestamps.

### Step 9:

Server determines notification condition information based on certificate state and emotion. Server uses certificate state codes, remaining validity periods, and emotion information as input. Server applies predefined rules, such as “if state is high-risk and emotion is high stress, delay notification until next low-stress window” or “if state is high-risk and emotion is relaxed, send immediately.” The data processing is a rule evaluation that produces a scheduled send time, a notification importance level, and one or more preferred notification media. The output is notification condition information records linked to specific certificates and users. Server stores these records in a notification condition table or directly in a notification queue.

### Step 10:

Server constructs prompt sentences for the generative AI model.

Server uses the certificate state, emotion information, and notification condition information as input to create a natural-language description of the situation and desired message characteristics. Server composes prompt sentences that include situation information (for example, domain, expiry date, risk level, and target medium) and expression condition information (for example, tone and length). The data processing is string construction and parameter substitution. Example prompt sentences generated by Server include: “Generate a short, calm email that informs the administrator that the digital certificate for example.com will expire in 7 days, has already been renewed successfully, and does not require immediate action. Use a neutral and non-alarming tone.”

“Generate a friendly push notification for a relaxed administrator, telling them that the digital certificate for example.com has been auto-renewed and will expire on 2023 Dec. 1, and that no further action is required.”

The output is a set of prompt sentences associated with notification identifiers.

### Step 11:

Server obtains notification text candidates from the generative AI model.

Server uses each prompt sentence as input to a generative AI model execution service. Server sends the prompt sentence and model configuration parameters, such as a temperature value and a maximum token count, to the service. The data processing at Server includes request assembly and response parsing. The output is a notification text candidate for each prompt sentence, received as natural-language text. Server stores these candidates in a notification text table linked to the corresponding notifications.

### Step 12:

Server post-processes notification text candidates and finalizes notification messages. Server uses the notification text candidates and internal requirements as input. Server checks for the presence of required elements such as domain name, expiry date, and renewal status. If any element is missing, Server may generate an additional prompt sentence to refine the candidate and repeat the call to the generative AI model. Server then selects or edits one candidate per channel according to the notification condition information, such as message length limits. The data processing includes validation, selection, and insertion of dynamic fields (for example, exact dates or URLs). The output is finalized notification messages ready for delivery, which Server stores in a notification queue with associated send times and media types.

### Step 13:

Server schedules and sends notification messages.

Server uses the notification queue entries and the current time as input. Server compares the scheduled send times to the current time and selects notifications whose send time has arrived or passed. Server formats messages according to the target medium (for example, push payloads for mobile notifications or email message bodies for emails). The data processing includes queue filtering, payload construction, and API calls to a message distribution infrastructure. The output is the actual delivery of notification messages to external delivery systems, and delivery status codes which Server records in a delivery log.

### Step 14:

Terminal receives notifications and updates the user interface.

Terminal uses incoming messages from the message distribution infrastructure as input. For push notifications, Terminal receives a payload containing a title, a body, and identifiers. Terminal displays the notification in a notification area and, when the user opens the app, requests detail data from Server using the identifiers. The data processing includes payload parsing and UI rendering. The output is an updated operation screen showing certificate status, expiry dates, and renewal results to the user.

### Step 15:

User reviews notifications and performs optional actions.

User uses the operation screen presented on Terminal as input to make decisions. User reads the notification content, checks certificate details, and, if an error or unresolved high-risk state is indicated, operates UI controls such as “retry renewal” or “mark as acknowledged.” The data processing at this stage is human decision-making translated into UI actions. The output is user input events, which Terminal sends back to Server as control requests or acknowledgements.

### Step 16:

Server collects response information and feedback information from the terminal. Server uses user input events and explicit feedback messages received from Terminal as input. Server structures this data into response information (for example, open time and action taken) and feedback information (for example, text comments and preference selections). The data processing includes timestamping, association with notification identifiers, and storage into response and feedback tables. The output is a persistent record of how each notification was received and evaluated by the user.

### Step 17:

Server generates additional prompt sentences for adaptive control.

Server uses response information and feedback information as input to build additional prompt sentences for the generative AI model. Server describes the observed user reactions and preferences and requests suggestions for adjusting notification timing or content. An example additional prompt sentence generated by Server is:

“Analyze this feedback: ‘Notification timing was bad; please send earlier in the day.’ Suggest how to adjust future digital certificate renewal notification timing for this administrator.” The data processing is text assembly that captures factual response data and feedback in a structured narrative. The output is additional prompt sentences associated with adaptation tasks.

### Step 18:

Server updates notification condition information based on AI-assisted adaptation. Server uses the AI-generated adaptation suggestions and existing scheduling parameters as input. Server parses the text to extract concrete rules, such as preferred time windows or modified importance thresholds. Server applies data operations to update configuration records and notification condition information for the corresponding user or group of users. The data processing includes rule extraction, parameter update, and consistency checks to ensure that new settings remain within allowed bounds. The output is updated notification condition information and adaptation control information that will be used in future executions of Steps 9 through 13 to refine the timing, priority, and content of notifications.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

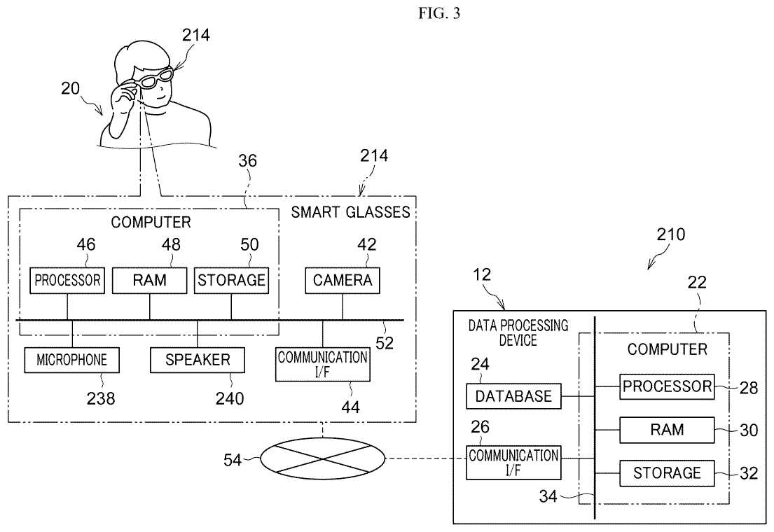

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

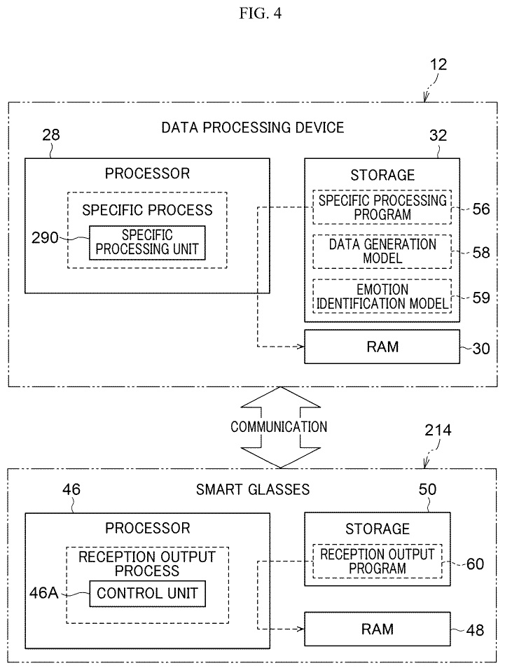

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

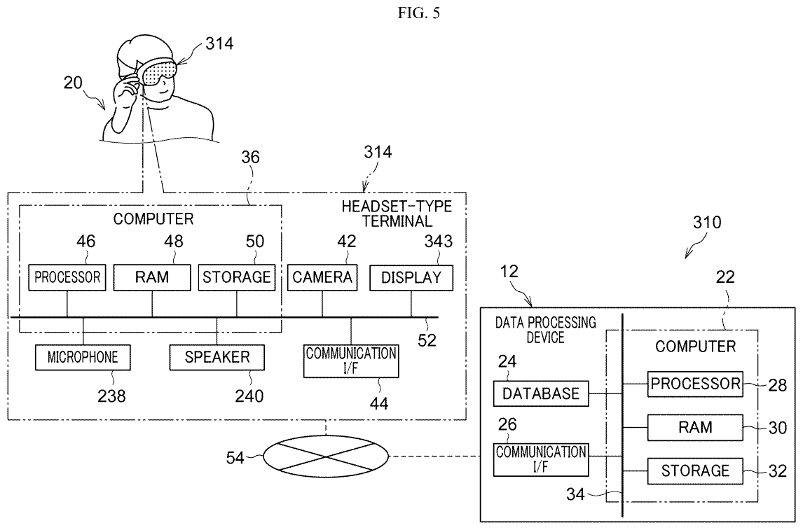

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

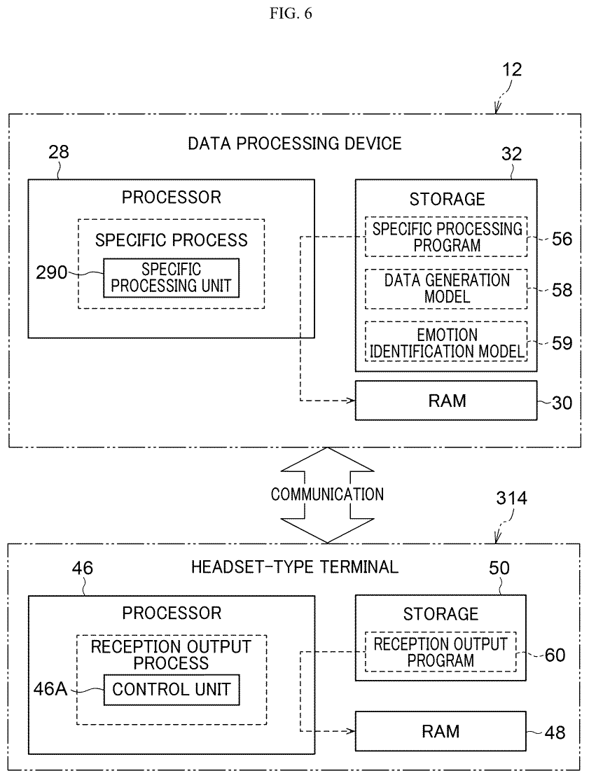

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

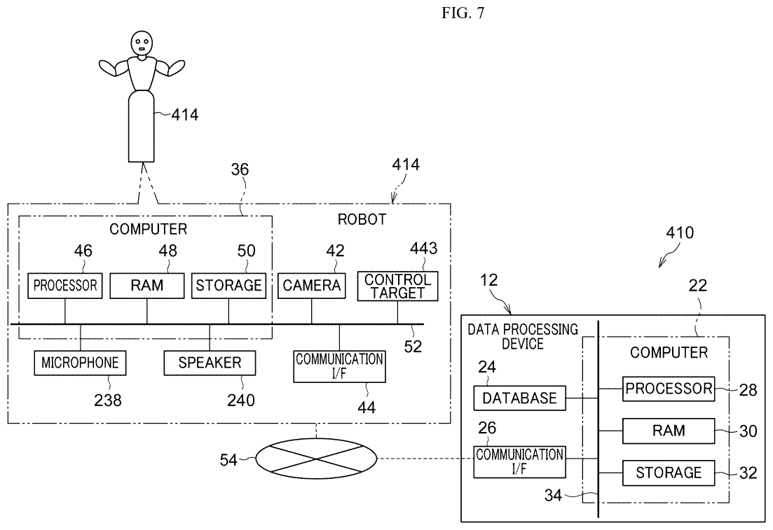

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

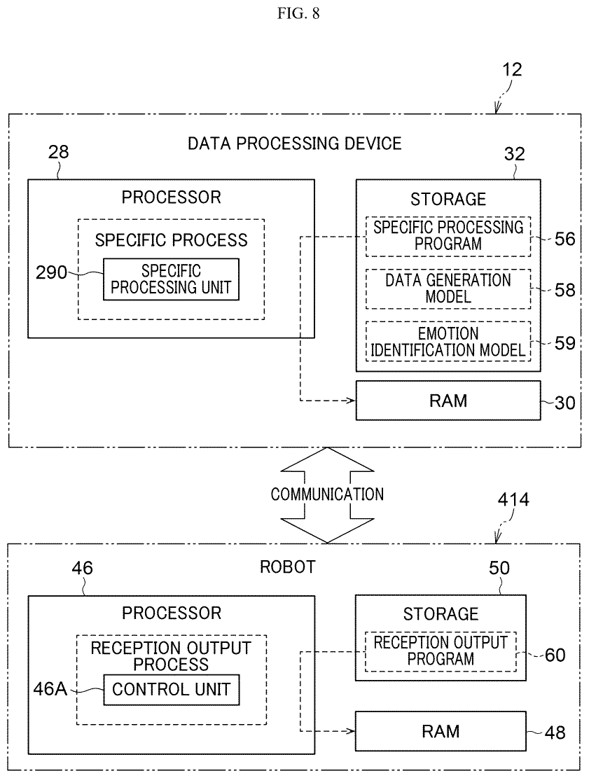

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

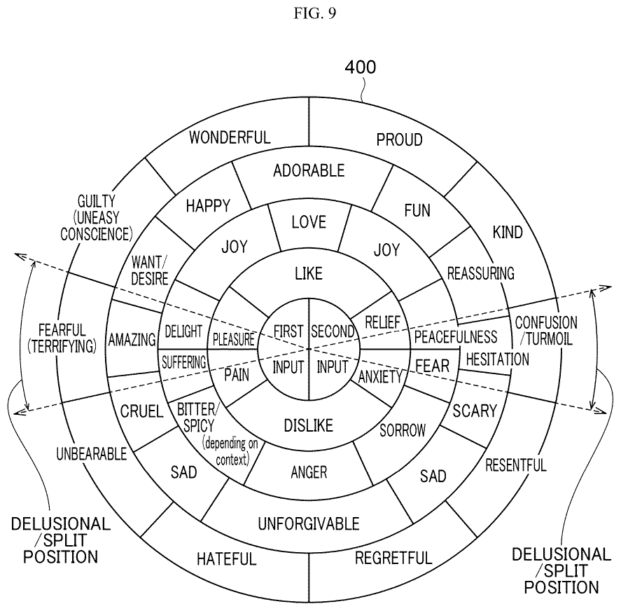

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

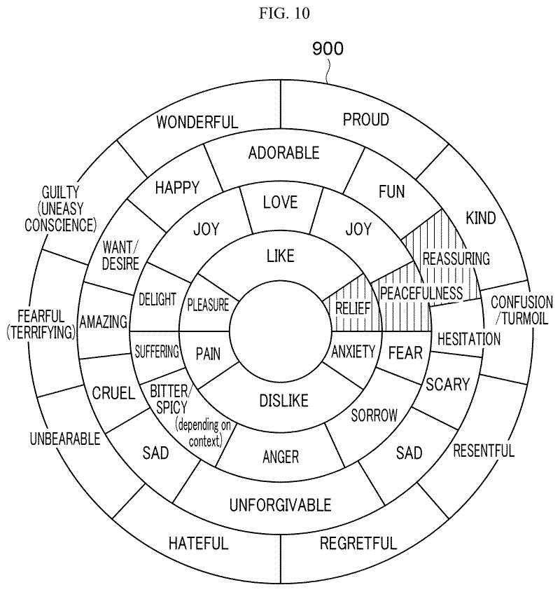

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire validity period information of a digital certificate on an information processing resource, to obtain date-time information, and to determine, based on the date-time information, whether a remaining validity period of the digital certificate is within a predetermined period,
generate, by using a generative artificial intelligence model, a prompt sentence for causing generation of processing procedures and configuration information for automatically executing a request for obtaining a new digital certificate to a certificate issuing service that uses a certificate issuing communication protocol, and for automatically executing an electronic transaction related to the obtaining of the new digital certificate, based on a result of the determination,
generate, by using the generative artificial intelligence model, a prompt sentence including processing procedures for processing authentication information provided from the certificate issuing service and for automatically generating or updating resource allocation information or name resolution information used for responding to the authentication information, generate, by using the generative artificial intelligence model, a prompt sentence including program code for automatically executing settlement processing using a connection interface for a settlement service, the settlement processing being required for completion of the electronic transaction, and for automatically executing digital certificate obtaining processing following the settlement processing,
generate, by using the generative artificial intelligence model, a prompt sentence including processing procedures for storing an obtained digital certificate and secret information in a storage resource, updating configuration information of a communication control information processing apparatus, and automatically performing verification and restart or reload of the configuration information,
generate, by using the generative artificial intelligence model, a prompt sentence for causing execution of a notification operation including destination information and notification media based on the validity period of the digital certificate or a result of renewal of the digital certificate, deploy, based on a prompt sentence input from a user and output processing procedures or program code from the generative artificial intelligence model, an executable automatic renewal process on the information processing resource, and register the automatic renewal process in a periodic execution control mechanism so as to continuously and automatically execute monitoring, obtaining, setting, and electronic transaction related to the digital certificate, and
generate, by using the generative artificial intelligence model, a prompt sentence including an evaluation index for analyzing information relating to an emotional state of the user and a prompt sentence including processing procedures for changing timing and content of the notification based on the emotional state indicated by the evaluation index.

### Supplementary 2

The system according to supplementary 1,
wherein the processor is configured to
generate, by using the generative artificial intelligence model, a prompt sentence including countermeasure procedures for avoiding suspension of information providing processing when it is determined that the validity period of the digital certificate is within the predetermined period, setting methods for automatically executing the countermeasure procedures, and notification content for notifying an administrator of an execution result of the countermeasure procedures.

### Supplementary 3

The system according to supplementary 1,
wherein the processor is configured to
generate, by using the generative artificial intelligence model, a prompt sentence defining notification control logic for dynamically changing a notification priority, a notification medium, a notification frequency, and a notification text based on information relating to the emotional state of the user and an evaluation value indicating the emotional state.

### Application Example 1

### Supplementary 1

A system comprising a processor,
wherein the processor is configured to obtain validity period information of cryptographic communication authentication information, calculate a remaining validity period based on a comparison between the validity period information and current time information, generate state information indicating that the remaining validity period is less than or equal to a predetermined threshold, and generate, by using a generative AI model, a prompt sentence that instructs initiation of an update process for the cryptographic communication authentication information based on the state information,
generate, based on the state information, secret information and signature request information corresponding to the cryptographic communication authentication information, automatically perform an acquisition request for new cryptographic communication authentication information by transmitting the signature request information through a cryptographic communication authentication information issuing communication interface, automatically complete transaction processing related to acquisition of the cryptographic communication authentication information by executing electronic settlement processing through a settlement communication interface, store the acquired cryptographic communication authentication information as configuration information of a service providing information processing apparatus, update communication control settings of the service providing information processing apparatus so as to apply the cryptographic communication authentication information, and generate, by using the generative AI model, a prompt sentence that instructs the storing, the updating, and the transaction processing,
acquire user state information including usage situation information and biometric reaction information from at least one of the service providing information processing apparatus and a portable information processing apparatus, analyze an emotional state of a user based on the user state information, determine notification content, a notification priority, and a notification execution time in accordance with the emotional state, the state information, transaction processing result information, and setting update result information, and generate, by using the generative AI model, a prompt sentence that instructs presentation of a notification message to the portable information processing apparatus in accordance with the determination result,
output, as structured data, management information including the state information, the transaction processing result information, and the setting update result information, in response to an acquisition request from an external terminal, and provide a service state, and receive the structured data as input information, and generate, by using the generative AI model, a prompt sentence that instructs generation, based on the input information, of an explanatory text that describes, in natural language, a management state, an update history, and a future update schedule of the cryptographic communication authentication information.

### Supplementary 2

The system according to supplementary 1,
wherein the processor is configured to generate, by using the generative AI model, a prompt sentence that instructs transmission, to the portable information processing apparatus, of a notification including warning content and recommended response content for preventing stoppage or security degradation of an information service, in a case where the remaining validity period of the cryptographic communication authentication information is less than or equal to the predetermined threshold based on the state information, or in a case where an abnormality is detected in transaction processing or setting update processing.

### Supplementary 3

The system according to supplementary 1,
wherein the processor is configured to determine a notification content optimization policy for adjusting a technical detail level, an expression difficulty level, and a message length included in the notification message based on the emotional state of the user, the usage situation information, and the management information, and to generate, by using the generative AI model, a prompt sentence that instructs generation, in accordance with the notification content optimization policy, of the notification message to be displayed on the portable information processing apparatus.

### Example 2

### Supplementary 1

A system comprising a processor,
wherein the processor is configured to monitor validity-period information of electronic certificate information corresponding to a plurality of information-providing services connected via a communication path, by activating a certificate-information acquisition program, externally invoking software having cryptographic processing functionality, acquiring the validity-period information output from the software, calculating a remaining validity period of the electronic certificate information by using the validity-period information and system-time information, and determining an approaching-expiration state by comparing the remaining validity period with a predetermined threshold,
generate, when the approaching-expiration state is determined, a prompt sentence including at least one piece of identification information corresponding to the electronic certificate information, expiration date information, and remaining validity-period information as input information, input the prompt sentence into a generative AI model having generation-support processing functionality, cause the generative AI model to generate a prompt sentence for instructing at least one of an update operation and a notification operation relating to the electronic certificate information, and acquire the generated prompt sentence, generate and transmit, based on the generated prompt sentence, an electronic communication message to a management terminal by using software having electronic communication-processing functionality, and display notification information indicating the approaching-expiration state of the electronic certificate information on a management screen having display-control functionality,
cause, based on the generated prompt sentence, external software to execute an acquisition process of new electronic certificate information and a setting process of the acquired electronic certificate information in an information processing apparatus, and cause an external program to execute procedure processing necessary for completing an electronic transaction process, and
estimate a user emotional state by analyzing user-attribute information and emotional-state estimation information, generate a prompt sentence including at least one of the emotional state and the approaching-expiration state as input information, input the prompt sentence into the generative AI model, cause the generative AI model to generate a prompt sentence for adjusting at least one of a notification timing and notification content, and control the notification timing and the notification content based on the generated prompt sentence.

### Supplementary 2

The system according to supplementary 1,
wherein the processor is configured to
generate, when the remaining validity period of the electronic certificate information is determined to be equal to or less than the predetermined threshold, a prompt sentence to be input to the generative AI model, the prompt sentence instructing generation of a template of a notification message to be transmitted when the validity period of the electronic certificate information is approaching, and, based on the template of the notification message acquired from the generative AI model, generate and transmit a notification message for preventing suspension of an information-providing service due to expiration of the electronic certificate information.

### Supplementary 3

The system according to supplementary 1,
wherein the processor is configured to input, into the generative AI model, a prompt sentence including information indicating the user emotional state and information indicating the remaining validity period of the electronic certificate information, acquire, from the generative AI model, a prompt sentence including control content for optimizing at least one of importance, transmission frequency, and display mode of a notification, and control at least one of a notification priority and a notification channel based on the acquired prompt sentence.

### Application Example 2

### Supplementary 1

A system comprising a processor,
wherein the processor is configured to acquire attribute information of a digital certificate, calculate a remaining validity period of the digital certificate on the basis of validity period information included in the attribute information and current time information, compare the remaining validity period with a plurality of predetermined threshold values, determine a certificate state in accordance with a result of the comparison, and generate state information indicating the certificate state, generate control information for causing a certification infrastructure to execute an issuance request for a new digital certificate and a fee settlement process when the certificate state satisfies an update condition, transmit and receive information with an external certificate issuing apparatus and an external settlement apparatus via a communication processing apparatus on the basis of the control information, acquire a new digital certificate and settlement result information, and reflect the acquired new digital certificate in setting information of an information processing apparatus for providing a network service, acquire emotion information indicating an estimated emotional state of a user on the basis of behavior information or input information acquired from a user terminal, and determine notification condition information indicating an execution timing of a notification and an importance degree of the notification on the basis of the emotion information and the certificate state,
generate a prompt sentence including situation information comprising a type of a notification target medium and a technical event to be notified and expression condition information comprising a writing style and a length required for the notification, on the basis of the certificate state, the emotion information, and the notification condition information, input the prompt sentence to a generative AI model, acquire response information including a notification text candidate corresponding to the situation information and the expression condition information, and select or generate a notification message from the notification text candidate on the basis of the notification condition information,
transmit the notification message to the user terminal via a message distribution infrastructure at a transmission time determined on the basis of the notification condition information, and instruct the user terminal to update at least one of a display of a state of the digital certificate and an operation screen, and
generate an adaptation control information by generating an additional prompt sentence for input to the generative AI model, the additional prompt sentence including response information and feedback information acquired from the user terminal for the notification, and updating at least one of the notification condition information and a generation condition of the prompt sentence on the basis of the response information and the feedback information.

### Supplementary 2

The system according to supplementary 1,
wherein the processor is configured to set, in the notification condition information, an execution timing of the notification to be delayed to a time zone in which a low stress state of the user is estimated when the certificate state indicates a service stop risk and the emotion information indicates a high stress state, and to set, in the notification condition information, the execution timing of the notification to be immediate or within a short time when the certificate state indicates the service stop risk and the emotion information indicates at least one of a low stress state and a concentration state.

### Supplementary 3

The system according to supplementary 1,
wherein the processor is configured to generate notification priority control information including priority information for each notification medium on the basis of the certificate state and the emotion information, generate a prompt sentence instructing use of the notification priority control information, input the prompt sentence to the generative AI model to cause the generative AI model to generate a plurality of notification messages adjusted for respective notification media, and select, from among the plurality of notification messages, at least one notification message to be transmitted to at least one notification medium.

What is claimed is:

1. A system comprising:
circuitry configured to:
obtain validity period information for cryptographic communication authentication information;
calculate a remaining validity period based on a comparison between the validity period information and current time information;
generate state information indicating that the remaining validity period is less than or equal to a predetermined threshold;
generate, using a generative artificial intelligence model, a first prompt sentence that instructs initiation of an update process for the cryptographic communication authentication information based on the state information;
generate, based on the state information, secret information and signature request information corresponding to the cryptographic communication authentication information;
transmit the signature request information through a cryptographic communication authentication information issuing communication interface to automatically perform an acquisition request for new cryptographic communication authentication information; and
store the acquired cryptographic communication authentication information as configuration information of a service providing information processing apparatus and update communication control settings of the service providing information processing apparatus to apply the cryptographic communication authentication information.

2. The system of claim 1, wherein the circuitry is configured to:
generate, using the generative artificial intelligence model, a second prompt sentence that instructs the storing, the updating, and transaction processing related to acquisition of the cryptographic communication authentication information; and
execute electronic settlement processing through a settlement communication interface to automatically complete the transaction processing.

3. The system of claim 2, wherein the circuitry is configured to:
acquire user state information comprising usage situation information and biometric reaction information from at least one of the service providing information processing apparatus and a portable information processing apparatus;
analyze an emotional state of a user based on the user state information;
determine notification content, a notification priority, and a notification execution time in accordance with the emotional state, the state information, transaction processing result information, and setting update result information; and
generate, using the generative artificial intelligence model, a third prompt sentence that instructs presentation of a notification message to the portable information processing apparatus in accordance with the determination result.

4. The system of claim 3, wherein analyzing the emotional state comprises applying a statistical analysis algorithm to the biometric reaction information to compute an emotional state score, and mapping the emotional state score to an emotional state category comprising at least one of a stressed state, a neutral state, a calm state, and an urgent state.

5. The system of claim 4, wherein determining the notification priority comprises computing a composite priority score as a function of the remaining validity period, the emotional state score, and a criticality level derived from the state information, wherein the composite priority score is used to order notification delivery relative to other pending notifications.

6. The system of claim 1, wherein obtaining the validity period information comprises querying a certificate store of the service providing information processing apparatus using a certificate identifier to retrieve a validity period field of the cryptographic communication authentication information.

7. The system of claim 6, wherein calculating the remaining validity period comprises computing a time difference between an expiration timestamp in the validity period information and the current time information, and expressing the remaining validity period as a duration value in predefined time units.

8. The system of claim 1, wherein generating the first prompt sentence comprises serializing the state information, the remaining validity period, and an update instruction template into a structured prompt format that instructs the generative artificial intelligence model to generate natural language update initiation guidance.

9. The system of claim 8, wherein the update instruction template specifies at least a certificate type field, a remaining validity duration field, and an action specification field that together constrain the generative artificial intelligence model to generate update initiation guidance scoped to the type of cryptographic communication authentication information indicated by the state information.

10. The system of claim 1, wherein generating the signature request information comprises constructing a certificate signing request comprising a public key derived from the secret information and subject attributes of the service providing information processing apparatus.

11. The system of claim 10, wherein transmitting the signature request information comprises establishing an encrypted communication channel to a certificate authority using a prior cryptographic communication authentication information and transmitting the certificate signing request via the encrypted communication channel.

12. The system of claim 1, wherein the circuitry is configured to:
output management information comprising the state information, transaction processing result information, and setting update result information as structured data in response to an acquisition request from an external terminal.

13. The system of claim 12, wherein the circuitry is configured to:
receive the structured data as input information and generate, using the generative artificial intelligence model, a fourth prompt sentence that instructs generation of an explanatory text describing in natural language a management state, an update history, and a future update schedule of the cryptographic communication authentication information.

14. The system of claim 13, wherein the fourth prompt sentence encodes the structured data as a serialized input section and includes an output format constraint specifying that the explanatory text is to be organized in sections covering the management state, the update history, and the future update schedule.

15. The system of claim 3, wherein the notification execution time is determined by applying a scheduling algorithm that selects a delivery time within a predefined notification window adjusted based on the emotional state category, such that delivery is deferred when the emotional state indicates a stressed state and the remaining validity period exceeds a secondary threshold.

16. The system of claim 1, wherein the cryptographic communication authentication information comprises a digital certificate conforming to an X.509 standard or an equivalent certificate standard.

17. The system of claim 1, wherein updating the communication control settings of the service providing information processing apparatus comprises deploying the acquired cryptographic communication authentication information to a secure storage location and reloading a communication service of the service providing information processing apparatus to apply the updated certificate.

18. A system comprising:
circuitry configured to:
obtain validity period information for cryptographic communication authentication information and calculate a remaining validity period based on a comparison between the validity period information and current time information;
generate state information when the remaining validity period is less than or equal to a predetermined threshold and generate, using a generative artificial intelligence model, a first prompt sentence instructing initiation of an update process based on the state information;
transmit signature request information through a cryptographic communication authentication information issuing communication interface to acquire new cryptographic communication authentication information and store the acquired cryptographic communication authentication information as configuration information; and
acquire user state information comprising biometric reaction information, analyze an emotional state based on the user state information, and generate a notification prompt sentence instructing presentation of a notification message in accordance with the emotional state and the state information.

19. The system of claim 18, wherein the circuitry is configured to apply a statistical analysis algorithm to the biometric reaction information to compute an emotional state score, map the emotional state score to an emotional state category, and compute a composite priority score as a function of the remaining validity period, the emotional state score, and a criticality level derived from the state information to determine a notification priority.

20. A method performed by circuitry, the method comprising:
obtaining validity period information for cryptographic communication authentication information;
calculating a remaining validity period based on a comparison between the validity period information and current time information;
generating state information indicating that the remaining validity period is less than or equal to a predetermined threshold;
generating, using a generative artificial intelligence model, a first prompt sentence instructing initiation of an update process for the cryptographic communication authentication information based on the state information;
generating secret information and signature request information and transmitting the signature request information through a cryptographic communication authentication information issuing communication interface to acquire new cryptographic communication authentication information;
storing the acquired cryptographic communication authentication information as configuration information and updating communication control settings to apply the cryptographic communication authentication information;
acquiring user state information comprising biometric reaction information and analyzing an emotional state of a user based on the user state information; and
generating, using the generative artificial intelligence model, a notification prompt sentence instructing presentation of a notification message in accordance with the emotional state and the state information.
